(19) United States
(12) Patent Application Publication
(10) Pub. No.: US 2024/0267969 A1
(43) Pub. Date: Aug. 8, 2024

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 18/639,761

(22) Filed: Apr. 18, 2024

Related U.S. Application Data
(63) Continuation of application No. PCT/JP2022/038728, filed on Oct. 18, 2022.
(60) Provisional application No. 63/257,246, filed on Oct. 19, 2021.

(51) Int. Cl. H04W 76/15; H04W 76/19; H04W 92/18

(52) U.S. Cl. CPC H04W 76/15; H04W 76/19; H04W 92/18

(57) ABSTRACT

A communication control method includes: configuring, for a relay node, dual connectivity in which a first parent node managing a master cell group is a master node and a second parent node managing a secondary cell group is a secondary node; transmitting, by the relay node, a first notification to a child node when a radio link failure is detected in one of a first backhaul link between the relay node and the first parent node and a second backhaul link between the relay node and the second parent node, the first notification indicating detection of the radio link failure; and transmitting, by the relay node, a second notification to the child node when recovery from the radio link failure occurs after transmitting the first notification, the second notification being transmitted after transmitting the first notification and indicating recovery from the radio link failure.

### RELATED APPLICATIONS

The present application is a continuation based on PCT Application No. PCT/JP2022/038728, filed on Oct. 18, 2022, which claims the benefit of U.S. Provisional Patent Application No. 63/257,246 filed on Oct. 19, 2021. The content of which is incorporated by reference herein in their entirety.

### TECHNICAL FIELD

The present disclosure relates to a communication control method used in a cellular communication system.

### BACKGROUND OF INVENTION

In the Third Generation Partnership Project (3GPP), which is a project for the standardization of cellular communication systems, introduction of a new relay node referred to as an Integrated Access and Backhaul (IAB) node (for example, see “3GPP TS 38.300 V16.7.0 (2021-09)”) has been studied. One or more relay nodes are involved in communication between a base station and a user equipment and perform relay for the communication.

### SUMMARY

In a first aspect, a communication control method is used in a cellular communication system. The communication control method includes: configuring, for a relay node, dual connectivity in which a first parent node managing a master cell group is a master node and a second parent node managing a secondary cell group is a secondary node; transmitting, by the relay node, a first notification to a child node when a radio link failure is detected in one of a first backhaul link between the relay node and the first parent node and a second backhaul link between the relay node and the second parent node, the first notification indicating detection of a radio link failure; and transmitting, by the relay node, a second notification to the child node when recovery from the radio link failure occurs, the second notification being transmitted after transmitting the first notification and indicating recovery from the radio link failure.

In a second aspect, a relay node is used in a cellular communication system. The relay node includes a processor. The processor executes: processing of configuring dual connectivity in which a first parent node managing a master cell group is a master node and a second parent node managing a secondary cell group is a secondary node; processing of transmitting a first notification to a child node when a radio link failure is detected in one of a first backhaul link between the relay node and the first parent node and a second backhaul link between the relay node and the second parent node, the first notification indicating detection of the radio link failure; and processing of transmitting a second notification to the child node, the second notification indicating recovery from the radio link failure, when recovery from the radio link failure occurs after transmitting the first notification.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, parent nodes, and child nodes.

FIG. 3 is a diagram illustrating a configuration example of a gNB (base station) according to the embodiment.

FIG. 4 is a diagram illustrating a configuration example of an IAB node (relay node) according to the embodiment.

FIG. 5 is a diagram illustrating a configuration example of a UE (user equipment) according to the embodiment.

FIG. 6 is a diagram illustrating an example of a protocol stack related to an RRC connection and a NAS connection of an IAB-MT.

FIG. 7 is a diagram illustrating an example of a protocol stack related to an F1-U protocol.

FIG. 8 is a diagram illustrating an example of a protocol stack related to an F1-C protocol.

FIG. 9 is a diagram illustrating an inter-node configuration example according to a first embodiment.

FIG. 10 is a diagram illustrating an inter-node configuration example according to the first embodiment.

FIG. 11 is a diagram illustrating an operation example according to the first embodiment.

FIG. 12 is a diagram illustrating an inter-node configuration example according to the first embodiment.

FIG. 13 is a diagram illustrating an inter-node configuration example according to a second embodiment.

FIG. 14 is a flowchart illustrating an operation example according to the second embodiment.

FIG. 15 is a flowchart illustrating an operation example according to the third embodiment.

FIG. 16 is a flowchart illustrating an operation example according to a fourth embodiment.

FIGS. 17A and 17B are diagrams illustrating inter-node configuration examples according to a fifth embodiment.

FIG. 18 is a flowchart illustrating an operation example according to a fifth embodiment.

FIG. 19 is a diagram illustrating an inter-node configuration example according to a sixth embodiment.

FIG. 20 is a flowchart illustrating an operation example according to the sixth embodiment.

FIGS. 21A to 21C are diagrams illustrating configuration examples of a topology according to a seventh embodiment.

FIG. 22 is a diagram illustrating an operation example according to a supplementary note.

FIG. 23 is a diagram illustrating an operation example according to the supplementary note.

### DESCRIPTION OF EMBODIMENTS

A cellular communication system in an embodiment is described with reference to the drawings. In the description of the drawings, the same or similar parts are denoted by the same or similar reference signs.

### Configuration of Cellular Communication System

A configuration example of the cellular communication system according to an embodiment is described. In an embodiment, a cellular communication system 1 is a 3GPP 5G system. Specifically, a radio access scheme in the cellular communication system 1 is New Radio (NR) being a 5G radio access scheme. Note that Long Term Evolution (LTE) may be at least partially applied to the cellular communication system 1. A future cellular communication system such as 6G may be applied to the cellular communication system 1.

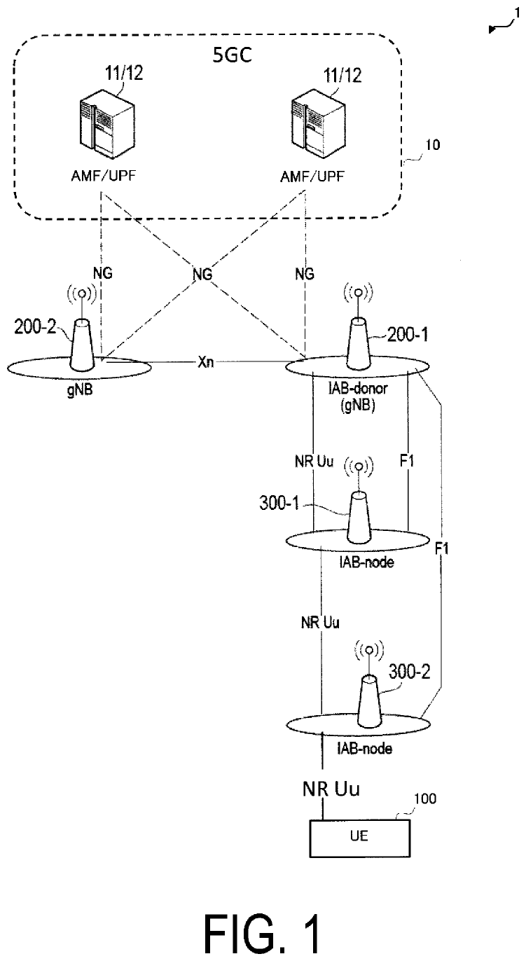

FIG. 1 is a diagram illustrating a configuration example of the cellular communication system 1 according to the embodiment.

As illustrated in FIG. 1, the cellular communication system 1 includes a 5G core network (5GC) 10, a User Equipment (UE) 100, base station apparatuses (hereinafter, also referred to as base stations in some cases) 200-1 and 200-2, and IAB nodes 300-1 and 300-2. The base station 200 may be referred to as a gNB.

An example in which the base station 200 is an NR base station is mainly described below, but the base station 200 may also be an LTE base station (i.e., an eNB).

Note that hereinafter, the base stations 200-1 and 200-2 may be referred to as a gNB 200 (or the base station 200 in some cases), and the IAB nodes 300-1 and 300-2 may be referred to as an IAB node 300.

The 5GC 10 includes an Access and Mobility Management Function (AMF) 11 and a User Plane Function (UPF) 12. The AMF 11 is an apparatus that performs various types of mobility controls and the like for the UE 100. The AMF 11 communicates with the UE 100 by using Non-Access Stratum (NAS) signaling, and thereby manages information of an area in which the UE 100 exists. The UPF 12 is an apparatus that performs transfer control of user data and the like.

Each gNB 200 is a fixed wireless communication node and manages one or more cells. The term “cell” is used to indicate a minimum unit of a wireless communication area. The term “cell” may be used to indicate a function or a resource for performing wireless communication with the UE 100. One cell belongs to one carrier frequency. Hereinafter, the cell and the base station may be used without distinction.

Each gNB 200 is interconnected to the 5GC 10 via an interface referred to as an NG interface. FIG. 1 illustrates a gNB 200-1 and a gNB 200-2 that are connected to the 5GC 10.

Each gNB 200 may be divided into a Central Unit (CU) and a Distributed Unit (DU). The CU and the DU are interconnected via an interface referred to as an F1 interface. An F1 protocol is a communication protocol between the CU and the DU and includes an F1-C protocol that is a control plane protocol and an F1-U protocol that is a user plane protocol.

The cellular communication system 1 supports an IAB that uses NR for the backhaul to enable wireless relay of the NR access. A donor gNB 200-1 (or a donor node, hereinafter also referred to as a “donor node” in some cases) is a donor base station that is a terminal node of an NR backhaul at the network side and includes additional functionality for supporting the IAB. The backhaul can implement multi-hop via a plurality of hops (i.e., a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted in two backhaul hops.

The UE 100 is a mobile wireless communication apparatus that performs wireless communication with the cells. The UE 100 may be any type of apparatus as long as the UE 100 is an apparatus that performs wireless communication with the gNB 200 or the IAB node 300. For example, the UE 100 includes a mobile phone terminal, a tablet terminal, a laptop PC, a sensor or an apparatus that is provided in a sensor, a vehicle or an apparatus that is provided in a vehicle, and an aircraft or an apparatus provided in an aircraft. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

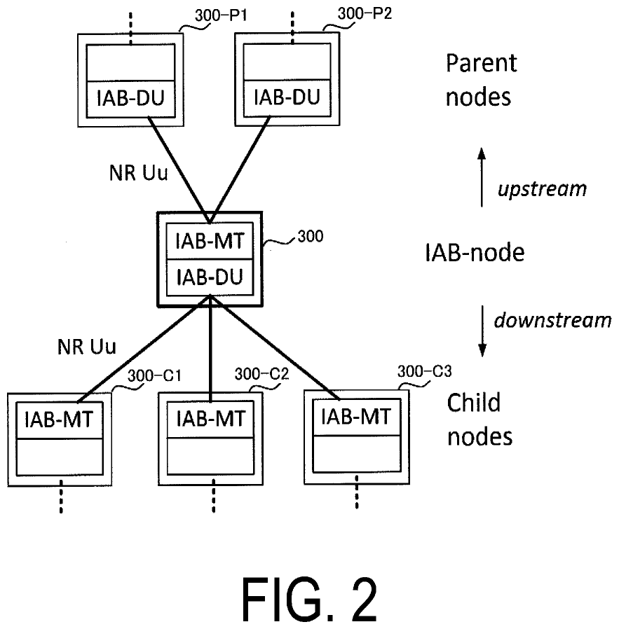

FIG. 2 is a diagram illustrating an example of a relationship between the IAB node 300, parent nodes, and child nodes.

As illustrated in FIG. 2, each IAB node 300 includes an IAB-DU corresponding to a base station functional unit and an IAB-Mobile Termination (MT) corresponding to a user equipment functional unit.

Neighboring nodes of the IAB-MT (i.e., upper node) of an NR Uu wireless interface are referred to as “parent nodes”. The parent node is the DU of a parent IAB node or the donor node 200. A radio link between the IAB-MT and each parent node is referred to as a backhaul link (BH link). FIG. 2 illustrates an example in which the parent nodes of the IAB node 300 are IAB nodes 300-P1 and 300-P2. Note that the direction toward the parent nodes is referred to as upstream. As viewed from the UE 100, the upper nodes of the UE 100 can correspond to the parent nodes.

Neighboring nodes of the IAB-DU (i.e., lower nodes) of an NR access interface are referred to as “child nodes”. The IAB-DU manages cells in a manner the same as, and/or similar to the gNB 200. The IAB-DU terminates the NR Uu wireless interface connected to the UE 100 and the lower IAB nodes. The IAB-DU supports the F1 protocol for the CU of the donor node 200-1. FIG. 2 illustrates an example in which the child nodes of the IAB node 300 are IAB nodes 300-C1 to 300-C3; however, the UE 100 may be included in the child nodes of the IAB node 300. Note that the direction toward the child nodes is referred to as downstream.

All of the IAB nodes 300 connected to the donor node 200 via one or more hops form a Directed Acyclic Graph (DAG) topology (which may be referred to as “topology” below) rooted at the donor node 200. In this topology, the neighboring nodes of the IAB-DU in the interface are child nodes, and the neighboring nodes of the IAB-MT in the interface are parent nodes as illustrated in FIG. 2. The donor node 200 performs, for example, centralized management on resources, topology, and routes of the IAB topology. The donor node 200 is a gNB that provides network access to the UE 100 via a network of backhaul links and access links.

### Configuration of Base Station

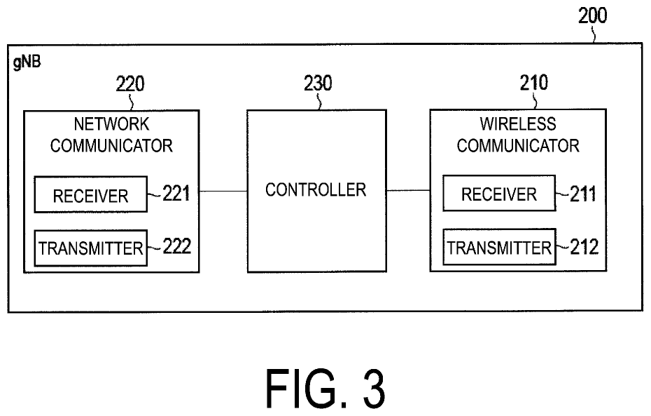

A configuration of the gNB 200 that is a base station according to the embodiment is described. FIG. 3 is a diagram illustrating a configuration example of the gNB 200. As illustrated in FIG. 3, the gNB 200 includes a wireless communicator 210, a network communicator 220, and a controller 230.

The wireless communicator 210 performs wireless communication with the UE 100 and performs wireless communication with the IAB node 300. The wireless communicator 210 includes a receiver 211 and a transmitter 212. The receiver 211 performs various types of reception under control of the controller 230. The receiver 211 includes an antenna and converts (down-converts) a radio signal received by the antenna into a baseband signal (reception signal) which is then transmitted to the controller 230. The transmitter 212 performs various types of transmission under control of the controller 230. The transmitter 212 includes an antenna and converts (up-converts) the baseband signal (transmission signal) output by the controller 230 into a radio signal which is then transmitted from the antenna.

The network communicator 220 performs wired communication (or wireless communication) with the 5GC 10 and performs wired communication (or wireless communication) with another neighboring gNB 200. The network communicator 220 includes a receiver 221 and a transmitter 222. The receiver 221 performs various types of reception under control of the controller 230. The receiver 221 receives a signal from an external source and outputs the reception signal to the controller 230. The transmitter 222 performs various types of transmission under control of the controller 230. The transmitter 222 transmits the transmission signal output by the controller 230 to an external destination.

The controller 230 performs various types of controls for the gNB 200. The controller 230 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. The controller 230 may perform all of the processing and operations in the gNB 200 in each embodiment described below.

### Configuration of Relay Node

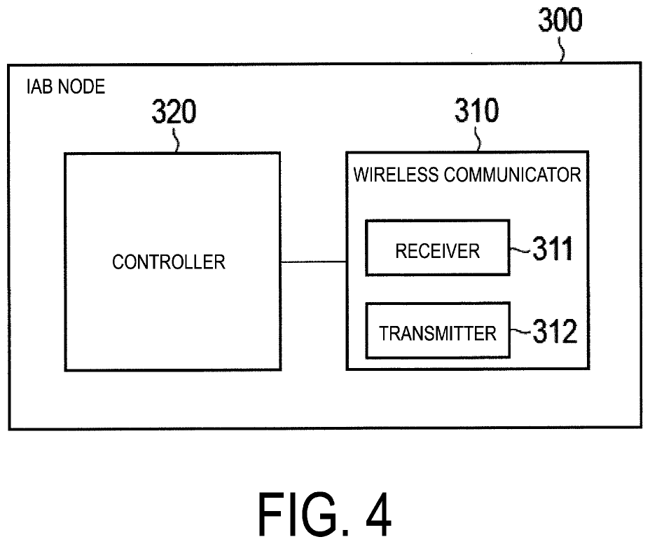

A configuration of the IAB node 300 that is a relay node (or a relay node apparatus, which may be also referred to as a “relay node” below) according to the embodiment will be described. FIG. 4 is a diagram illustrating a configuration example of the IAB node 300. As illustrated in FIG. 4, the IAB node 300 includes a wireless communicator 310 and a controller 320. The IAB node 300 may include a plurality of wireless communicators 310.

The wireless communicator 310 performs wireless communication with the gNB 200 (BH link) and wireless communication with the UE 100 (access link). The wireless communicator 310 for the BH link communication and the wireless communicator 310 for the access link communication may be provided separately.

The wireless communicator 310 includes a receiver 311 and a transmitter 312. The receiver 311 performs various types of reception under control of the controller 320. The receiver 311 includes an antenna and converts (down-converts) a radio signal received by the antenna into a baseband signal (reception signal) which is then transmitted to the controller 320. The transmitter 312 performs various types of transmission under control of the controller 320. The transmitter 312 includes an antenna and converts (up-converts) the baseband signal (transmission signal) output by the controller 320 into a radio signal which is then transmitted from the antenna.

The controller 320 performs various types of controls in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. The controller 320 may perform all of the processing and operations in the IAB node 300 in each embodiment described below.

### Configuration of User Equipment

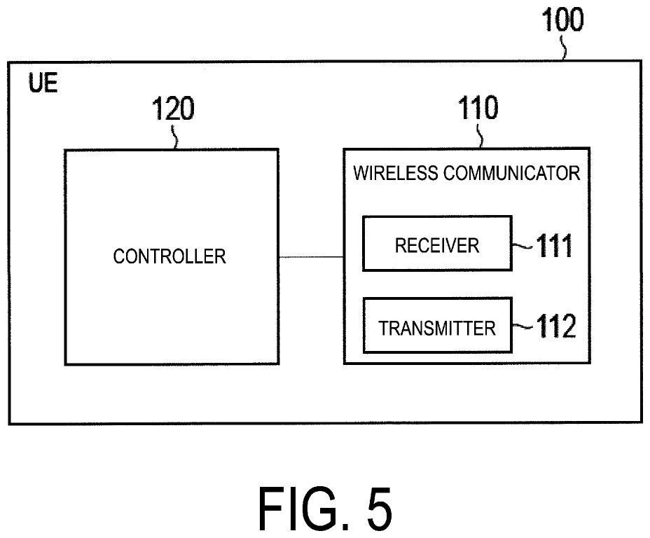

A configuration of the UE 100 that is a user equipment according to the embodiment is described next. FIG. 5 is a diagram illustrating a configuration example of the UE 100. As illustrated in FIG. 5, the UE 100 includes a wireless communicator 110 and a controller 120.

The wireless communicator 110 performs wireless communication in the access link, i.e., wireless communication with the gNB 200 and wireless communication with the IAB node 300. The wireless communicator 110 may also perform wireless communication in a sidelink, i.e., wireless communication with another UE 100. The wireless communicator 110 includes a receiver 111 and a transmitter 112. The receiver 111 performs various types of reception under control of the controller 120. The receiver 111 includes an antenna and converts (down-converts) a radio signal received by the antenna into a baseband signal (reception signal) which is then transmitted to the controller 120. The transmitter 112 performs various types of transmission under control of the controller 120. The transmitter 112 includes an antenna and converts (up-converts) the baseband signal (transmission signal) output by the controller 120 into a radio signal which is then transmitted from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. The controller 120 may perform all of the processing in the UE 100 in each embodiment described below.

### Configuration of Protocol Stack

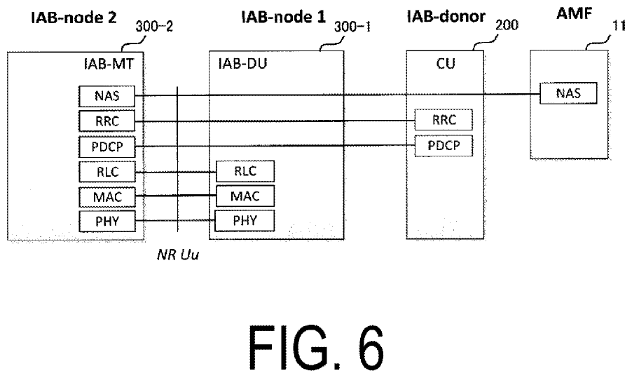

A configuration of a protocol stack according to the embodiment is described next. FIG. 6 is a diagram illustrating an example of a protocol stack related to an RRC connection and a NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs preferential control of data, retransmission processing using a hybrid ARQ (HARQ), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines the transport format (transport block size, modulation and coding scheme (MCS)) and the assignment of resource blocks in the uplink and the downlink.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression and decompression, and encryption and decryption. Data and control information are transmitted between the PDCP layer of the IAB-MT of the IAB node 300-2 and the PDCP layer of the donor node 200 via a radio bearer.

The RRC layer controls a logical channel, a transport channel, and a physical channel according to establishment, re-establishment, and release of a radio bearer. RRC signaling for various configurations is transmitted between the RRC layer of the IAB-MT of the IAB node 300-2 and the RRC layer of the donor node 200. When an RRC connection to the donor node 200 is present, the IAB-MT is in an RRC connected state. When no RRC connection to the donor node 200 is present, the IAB-MT is in an RRC idle state.

The NAS layer which is positioned upper than the RRC layer performs session management, mobility management, and the like. NAS signaling is transmitted between the NAS layer of the IAB-MT of the IAB node 300-2 and the AMF 11.

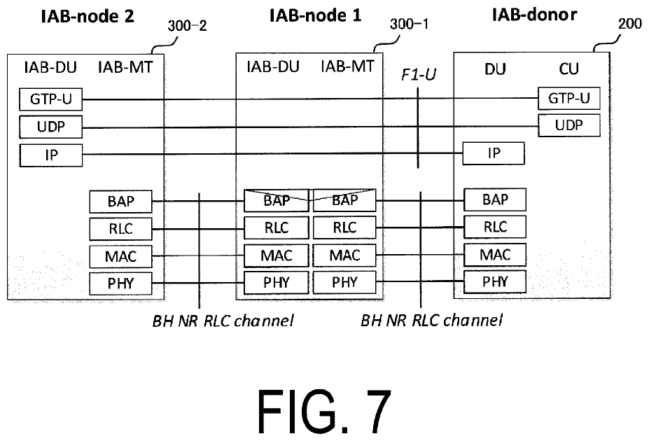

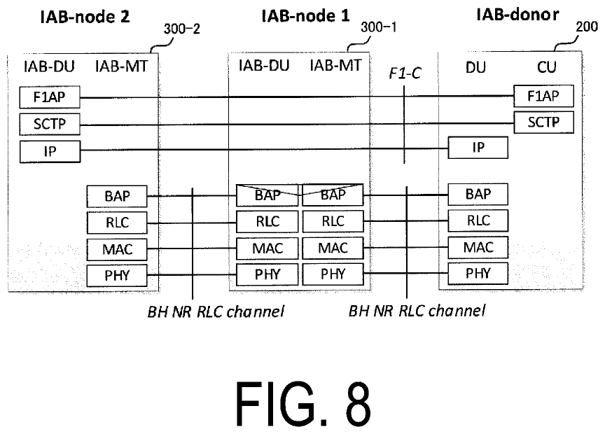

FIG. 7 is a diagram illustrating a protocol stack related to an F1-U protocol. FIG. 8 is a diagram illustrating a protocol stack related to an F1-C protocol. An example is illustrated in which the donor node 200 is divided into a CU and a DU.

As illustrated in FIG. 7, each of the IAB-MT of the IAB node 300-2, the IAB-DU of the IAB node 300-1, the IAB-MT of the IAB node 300-1, and the DU of the donor node 200 includes a Backhaul Adaptation Protocol (BAP) layer as a higher layer of the RLC layer. The BAP layer performs routing processing, and bearer mapping and demapping processing. In the backhaul, the IP layer is transmitted via the BAP layer to allow routing through a plurality of hops.

In each backhaul link, a Protocol Data Unit (PDU) of the BAP layer is transmitted by the backhaul RLC channel (BH NR RLC channel). Configuring each BH link to include a plurality of backhaul RLC channels enables the prioritization and QoS control of traffic. The association between the BAP PDU and the backhaul RLC channel is executed by the BAP layer of each IAB node 300 and the BAP layer of the donor node 200.

As illustrated in FIG. 8, the protocol stack of the F1-C protocol includes an F1AP layer and an SCTP layer instead of a GTP-U layer and a UDP layer illustrated in FIG. 7.

Note that in the description below, processing or operation performed by the IAB-DU and the IAB-MT of the IAB may be simply described as processing or operation of the “IAB”. For example, in the description, transmitting, by the IAB-DU of the IAB node 300-1, a message of the BAP layer to the IAB-MT of the IAB node 300-2 is assumed to correspond to transmitting, by the IAB node 300-1, the message to the IAB node 300-2. Processing or operation of the DU or CU of the donor node 200 may be described simply as processing or operation of the “donor node”.

An upstream direction and an uplink (UL) direction may be used without distinction. A downstream direction and a downlink (DL) direction may be used without distinction.

### First Embodiment

A first embodiment will be described.

First, in the first embodiment, a Type2 BH RLF Indication and a Type3 BH RLF Indication are described.

### Type2 BH RLF Indication and Type3 BH RLF Indication

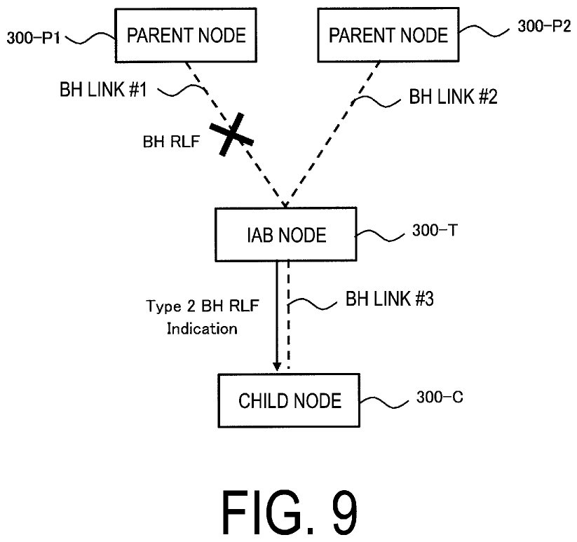

FIG. 9 is a diagram illustrating an inter-node configuration example according to the first embodiment.

The cellular communication system 1 illustrated in FIG. 9 includes an IAB node 300-T, the parent node (IAB node) 300-P1, the parent node 300-P2, and the child node (IAB node) 300-C.

The IAB node 300-P1 is a parent node of the IAB node 300-T. Hereinafter, the IAB node 300-P1 may be also referred to as the parent node 300-P1. A backhaul link (BH link) #1 is established between the IAB-DU of the parent node 300-P1 and the IAB-MT of the IAB node 300-T. Note that the parent node 300-P1 may be (a DU #1 of) the donor node 200.

The IAB node 300-P2 is also a parent node of the IAB node 300-T. Hereinafter, the IAB node 300-P2 may be also referred to as the parent node 300-P2. A BH link #2 is established between the IAB-DU of the parent node 300-P2 and the IAB-MT of the IAB node 300-T. Note that the parent node 300-P2 may be (a DU #2 of) the donor node 200.

The IAB node 300-C is a child node of the IAB node 300-T. Hereinafter, the IAB node 300-C may be also referred to as the child node 300-C. A BH link #3 is established also between the IAB-MT of the child node 300-C and the IAB-DU of the IAB node 300-T.

Assume that in such a configuration, a Radio Link Failure in the BH link #1 (BH RLF) occurs and the IAB-MT of the IAB node 300-T detects the BH RLF.

The IAB-DU of the IAB node 300-T can transfer a Type1 BH RLF Indication (hereinafter also referred to as a “Type1 Indication”) to child node 300-C on the downstream side. The Type1 Indication is an example of a failure occurrence notification indicating the detection of a BH RLF.

When the IAB-MT of the IAB node 300-T detects an operation of recovering from the BH RLF, the IAB-DU of the IAB node 300-T can transmit the Type2 BH RLF Indication (hereinafter also referred to as the “Type2 Indication”) to the child node 300-C. The Type2 Indication is an example of a recovery attempt notification (or failure occurrence notification) indicating that the recovery from the BH RLF is being attempted.

Note that, when not distinguishing between the Type1 Indication and the Type2 Indication, the IAB-DU of the IAB node 300-T can transmit a Type1/2 BH RLF Indication (hereinafter also referred to as a “Type1/2 Indication”) to the child node. The Type1/2 Indication is also an example of the failure occurrence notification.

Here, the Type1 Indication may be replaced with the Type2 Indication. The Type1 Indication is transmitted when a BH RLF is detected, and the Type2 Indication is transmitted when a recovery attempt is made. However, the IAB-MT of the IAB node 300-T makes recovery attempt processing of the BH RLF immediately after detecting the BH RLF. Therefore, two Indications can be regarded as substantially the same Indication.

Further, when the IAB-MT of the IAB node 300-T detects the recovery from the BH RLF, the IAB-DU of the IAB node 300-T can transmit the Type3 BH RLF Indication (hereinafter also referred to as the “Type3 Indication”) to the child node 300-C. The Type3 Indication may be a recovery notification indicating that the BH link recovers from the BH RLF.

Further, when the IAB-MT of the IAB node 300-T detects that the recovery from the BH RLF has failed, the IAB-DU of the IAB node 300-T can transmit a Type4 BH RLF Indication (hereinafter also referred to as a “Type4 Indication”) to the child node. The Type4 BH RLF Indication is also a failure notification indicating that the BH link has failed to recover from the BH RLF.

FIG. 9 illustrates an example in which the IAB node 300-T transmits the Type2 Indication to the child node 300-C.

Note that these Type BH RLF Indications may be included in a BAP Control PDU or a MAC CE for transmission.

### Dual Connectivity (DC)

The IAB node 300-T can utilize resources provided by two different parent nodes 300-P1 and 300-P2. One of the parent nodes may be a master node (MN) that manages a master cell group (hereinafter also referred to as an “MCG”). The other of the parent nodes may be a secondary node (SN) that manages a secondary cell group (hereinafter also referred to as an “SCG”).

The MCG is a cell group of serving cells associated with the master node. The MCG includes a primary cell (SpCell or PCell) and optionally one or more secondary cells (SCells).

The SCG is a cell group of serving cells associated with the secondary node. The SCG includes a primary cell (SpCell or PSCell) and optionally one or more secondary cells (SCells). The SpCell is a primary cell in the MCG and is also a primary cell in the SCG.

Here, the master node and the secondary node are logical entities. In the first embodiment, the master node corresponds to the parent node 300-P1 node and the secondary node corresponds to the parent node 300-P2 in the description below.

The IAB node 300-T can connect to the master node that manages the MCG and can connect to the secondary node when managing the SCG. In this case, the IAB node 300-T simultaneously connects to the parent nodes 300-P1 and 300-P2 to perform wireless communication. This can improve throughput in the IAB node 300-T.

One type of the dual connectivity (hereinafter, also referred to as the “DC”) includes EN-DC ((E-UTRA (Evolved Universal Terrestrial Radio Access)-NR Dual Connectivity)). In EN-DC, the IAB node 300-T is connected to one eNB (evolved Node B) serving as a master node and one en-gNB serving as a secondary node. The eNB is an LTE base station providing an E-UTRA service. The en-gNB is an NR base station providing an NR service. For example, in the example of FIG. 9, the parent node 300-P1 that is the master node may be the eNB and the parent node 300-P2 that is the secondary node may be the en-gNB. In EN-DC, the MCG performs processing related to control (C-Plane). On the other hand, the SCG performs processing related to data (U-plane).

Other types of DC include an NR-DC (NR-NR Dual Connectivity). In the NR-DC, both the master node and the secondary node are gNBs. In the NR-DC, both the MCG and the SCG may perform processing related to the control and the data. Thus, for example, the IAB node 300-T can simultaneously transmit and receive data to and from the parent nodes 300-P1 and 300-P2, both of which are the gNBs.

### Communication Control Method According to First Embodiment

The 3GPP has agreed that, for the single connectivity, the Type2 Indication is generated (or transmitted) when a BH RLF (hereinafter, also referred to as an “RLF”) is detected.

On the other hand, the 3GPP has not decided yet, for DC, when the Type2 Indication is to be transmitted.

For DC also, the Type2 Indication may be generated (or transmitted) when an RLF is detected same as, and/or similar to, the single connectivity.

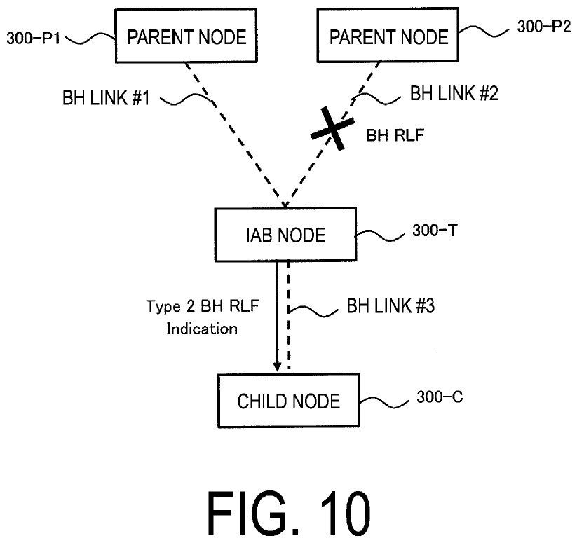

In this case, two cases are conceivable. Specifically, there is a case where an RLF occurring on an MCG side is detected and the Type2 Indication is transmitted, and a case where an RLF occurring on an SCG side is detected and the Type2 Indication is transmitted. FIG. 9 illustrates an example of the former case, and FIG. 10 illustrates an example of the latter case.

In such a case, the child node 300-C receiving the Type2 Indication may not know whether the RLF occurs on the MCG side or the SCG side only by receiving the Type2 Indication.

Therefore, the IAB node 300-T can add additional information to the Type2 Indication and transmit the Type2 Indication. The child node 300-C receiving the additional information can perform routing processing, rerouting processing, or the like based on the additional information.

Furthermore, an RLF may occur (simultaneously) on both the MCG side and the SCG side. In this case, the child node 300-C receives two of the Type2 Indication corresponding to the RLF occurring on the MCG side and the Type2 Indication corresponding to the RLF occurring on the SCG side.

It is assumed that, thereafter, recovery from the RLF at the MCG side has occurred. In this case, the IAB node 300-T transmits the Type3 Indication to the child node 300-C.

Even when the child node 300-C receives the Type3 Indication, the child node 300-C may not know whether recovery from the RLF at the MCG side has occurred or recovery from the RLF at the SCG side has occurred.

Therefore, in the first embodiment, the IAB node 300-T adds the additional information to the Type3 Indication and transmits the Type3 Indication to the child node 300-C.

To be more specific, first, the relay node (e.g., the IAB node 300-T) is configured with dual connectivity in which a first parent node (e.g., the parent node 300-P1) managing the master cell group is the master node and a second parent node (e.g., the parent node 300-P2) managing the secondary cell group is the secondary node. Second, the relay node transmits, a second notification (e.g., the Type3 Indication) to the child node (e.g., the child node 300-C), the second notification indicating recovery from the radio link failure in a first backhaul link (e.g., a BH link #1) between the relay node and the first parent node, and/or a second backhaul link (e.g., a BH link #2) between the relay node and the second parent node. Here, the second notification includes second additional information, and the second additional information indicates at least a second routing ID that is available.

This allows the child node 300-C to perform appropriate processing such as returning to a normal routing operation when having performed local rerouting, based on the available routing ID, for example.

Note that the routing ID includes a destination BAP address (Destination) and a path identifier (Path ID).

### Operation Example According to First Embodiment

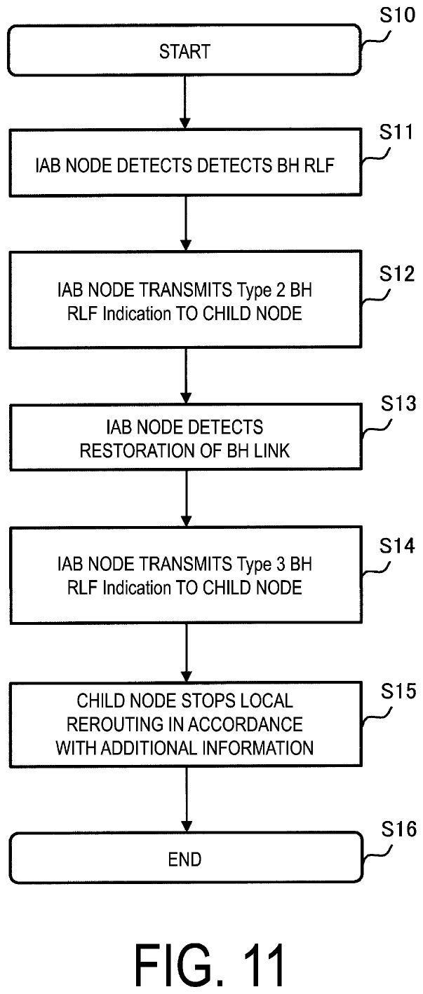

FIG. 11 is a diagram illustrating an operation example according to the first embodiment.

The IAB node 300-T starts processing in step S10 as illustrated in FIG. 11.

Note that the IAB node 300-T is configured with DC after step S10 and before step S11. That is, the IAB node 300-T is configured with DC in which the parent node 300-P1 managing the MCG is a master node and the parent node 300-P2 managing the SCG is a secondary node.

In step S11, the IAB node 300-T detects an RLF (or an RLF being restored). The RLF may be the BH link #1 on the MCG side or the BH link #2 on the SCG side. The RLFs may occur simultaneously in the BH link #1 on the MCG side and the BH link #2 on the SCG side. The IAB-MT of the IAB node 300-T may detect the RLF for each RLF whether the RLFs occur simultaneously or individually on the respective BH links.

In step S12, the IAB node 300-T transmits the Type2 Indication to the child node 300-C. The IAB node 300-T transmits the Type2 Indication independently for each detected RLF. For example, the IAB node 300-T, when detecting an RLF occurring in the BH link #1 on the MCG side, transmits the Type2 Indication corresponding to the RLF, and when detecting an RLF occurring in the BH link #2 on the SCG side, transmits the Type2 Indication corresponding to the RLF.

Here, the IAB node 300-T adds the additional information to the Type2 Indication and transmits the Type2 Indication. The additional information may be information of a route affected by the RLF.

Specifically, the additional information may include at least one selected from the group consisting of an unavailable CG (e.g., information indicating whether the MCG is unavailable or whether the SCG is unavailable), an unavailable routing ID, and unavailable link quality. Further, the additional information may include an unavailable BH RLC channel ID (BH RLC channel ID). By receiving the unavailable BH RLC channel ID, the child node 300-C can stop transmission to the BH RLC channel or perform routing to another BH RLC channel.

In the description below, the child node 300-C performs the local rerouting to another parent node in response to receiving the Type2 Indication including the additional information. The local rerouting is, for example, switching transmission from one parent node to another parent node on an alternate path. In the example of FIG. 9, the child node 300-C switches transmission from the IAB node 300-T (the parent node for the child node 300-C) to another IAB node on the alternate path (another parent node for the child node 300-C).

Referring back to FIG. 11, in step S13, the IAB node 300-T detects a restoration of the RLF occurring in the BH link. The IAB node 300-T detects the restoration from the RLF on the MCG side and the restoration from the RLF on the SCG side independently of each other.

In step S14, the IAB node 300-T transmits the Type3 Indication to the child node 300-C. The IAB node 300-T, when detecting the restoration from the RLF on the MCG side, transmits the Type3 Indication corresponding to the RLF, and when detecting the restoration from the RLF on an SCG side, transmits the Type3 Indication corresponding to the RLF.

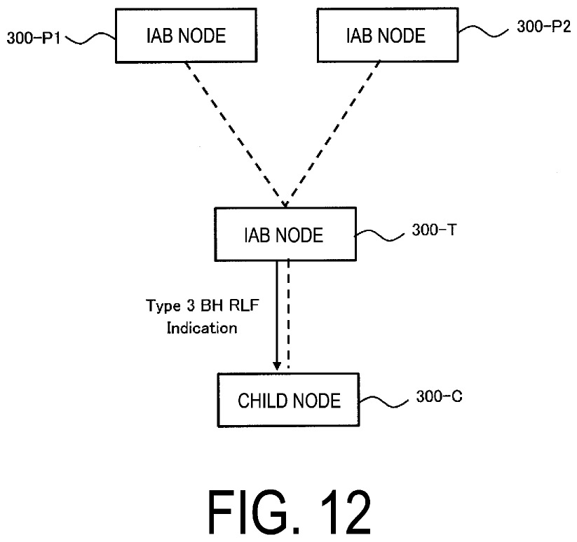

FIG. 12 is a diagram illustrating an inter-node configuration example according to the first embodiment. As illustrated in FIG. 12, the IAB node 300-T transmits the Type3 Indication to the child node 300-C.

Here, the IAB node 300-T adds the additional information to the Type3 Indication and transmits the Type3 Indication. The additional information may be information of a route affected by the restoration.

Specifically, the additional information includes at least one selected from the group consisting of a CG that is available (e.g., information indicating whether the MCG or the SCG is available), a routing ID that is available, available link quality (e.g., update of an available throughput), and a BH RLC channel ID that is available.

In step S15, the child node 300-C, in response to receiving the Type3 Indication, stops the local rerouting operation and performs the normal routing operation in accordance with the additional information. For example, the child node 300-C stops the local rerouting for the routing ID that is available. For example, assume that the child node 300-C receives a routing ID #1 that is available as the additional information and is performing the local rerouting for a routing ID #2. In this case, the routing ID #2 is still the unavailable routing ID. The child node 300-C continues the local rerouting for the routing ID #2.

In this way, the child node 300-C receiving the additional information can grasp the information of the route affected by the restoration, and can control communication in accordance with the additional information.

In step S16, the child node 300-C ends a series of processing operations.

### Variation of First Embodiment

In the example described according to the first embodiment, the IAB node 300-T transmits the Type3 Indication including the additional information to the child node 300-C. For example, the IAB node 300-T may transmit the Type3 Indication not including the additional information. In this case, the child node 300-C may determine that all of the routing IDs of the BH links associated with the Type3 Indication are available.

### Second Embodiment

A second embodiment is described.

For the local rerouting, inter-donor DU rerouting may be performed. The inter-donor rerouting is, for example, rerouting in which a path is switched from a first DU of the donor node 200 to a second DU of the donor node 200.

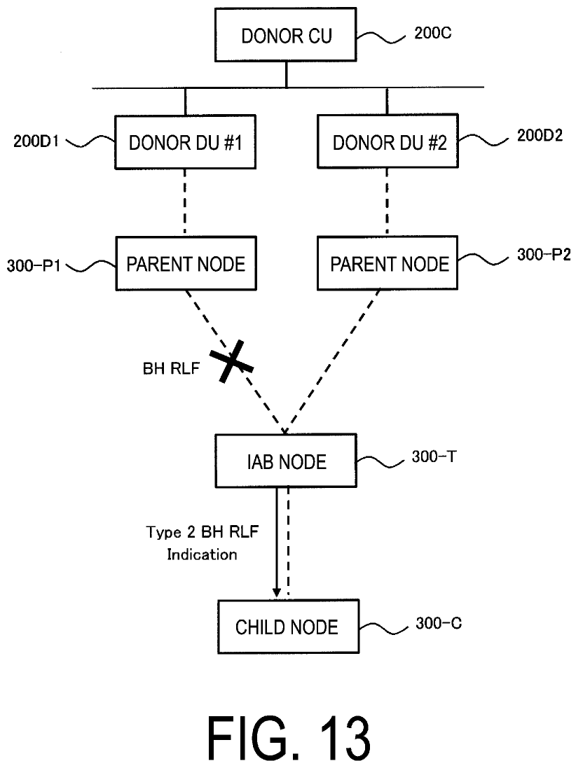

FIG. 13 is a diagram illustrating an inter-node configuration example according to the second embodiment. FIG. 13 illustrates an example of inter-donor rerouting.

In the example of FIG. 13, the DU #1 of the donor node 200 (hereinafter, referred to as the “donor DU #1”) (200D1) is switched to the DU #2 of the donor node 200 (hereinafter, the “donor DU #2”) (200D2) by the inter-donor rerouting. In this case, a destination of the packet in the upstream direction will be changed from a BAP address of the donor DU #1 to a BAP address of the donor DU #2.

Note that FIG. 13 illustrates an example in which a DC configuration is made between the IAB node 300-T and the parent node 300-P1, and the IAB node 300-T and the parent node 300-P2, as in the first embodiment.

When the IAB node 300-T detects an RLF in the BH link on the MCG side or the BH link on the SCG side, the IAB node 300-T can transmit the Type2 Indication including the additional information.

Here, the IAB node 300-T, when detecting the RLF in the BH link on the MCG side, may transmit all of the routing IDs having Destinations (the BAP addresses of the donor DU #1) associated with the MCG side as the additional information.

The IAB node 300-T, when detecting the RLF in the BH link on the SCG side, may transmit all of the routing IDs having Destinations (the BAP addresses of the donor DU #2 (200D2)) associated with the SCG side as the additional information.

However, the overhead of the additional information is large for the IAB node 300-T to transmit all of the routing IDs associated with the Destinations as the additional information.

Therefore, the second embodiment describes an example in which the IAB node 300-T transmits to the child node 300-C the destination BAP address that is unavailable as the additional information of the Type2 Indication.

Specifically, first, the relay node (e.g., the IAB node 300-T) confirms, a destination BAP address included in a routing ID that is unavailable due to a radio link failure occurring in a backhaul link between the relay node and the parent node (e.g., the parent node 300-P1). Second, the relay node transmits a first notification to the child node (e.g., the child node 300-C), the first notification indicating that recovery from the radio link failure is being attempted. Here, the first notification includes the additional information, and the additional information includes the destination BAP address.

This allows the IAB node 300-T to reduce a size of the additional information added to the Type2 Indication and suppress the overhead of the additional information.

### Operation Example According to Second Embodiment

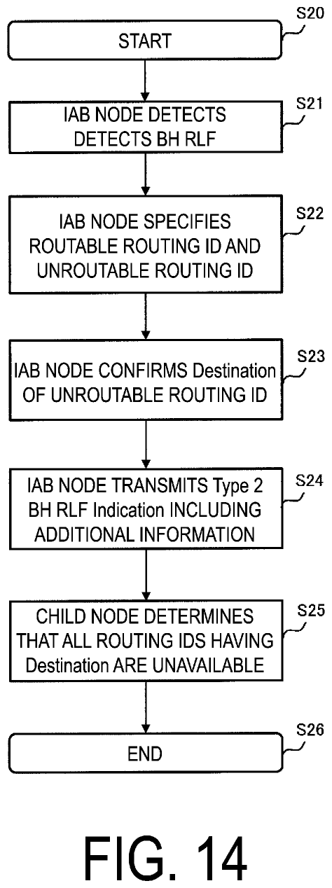

FIG. 14 is a flowchart illustrating an operation example according to the second embodiment.

The IAB node 300-T starts processing in step S20 as illustrated in FIG. 14.

In step S21, the IAB node 300-T detects an RLF (or an RLF being restored).

In step S22, the IAB node 300-T specifies a routable routing ID and an unroutable routing ID. Specifically, for example, the following is performed.

First, a description for the single connectivity is given. The single connectivity is a form in which the IAB node 300-T has no alternate path and is connected to only one parent node 300-P. For the single connectivity, since no alternative path exists, all of the routing IDs are unroutable routing IDs. In this case, no routable routing ID exists. Therefore, for the single connectivity, all of the routing IDs may be unroutable routing IDs.

Second, a description for a DC connection is given. For example, for the DC connection, the IAB node 300-T is simultaneously connected to two parent nodes 300-P1 and 300-P2. Note that when the DC connection is performed, the DC configuration is made for the IAB node 300-T between steps S20 and S21.

For the DC connection, routing or rerouting may be performed by an intra-donor-DU (“Intra-donor-DU”). The intra-donor DU is a form in which the Destination is the same and a plurality of paths exists. For the intra-donor DU, although an RLF is detected, some routing IDs are unavailable because the alternate paths exist, but other routing IDs are available.

For the DC connections, routing or rerouting may be performed between the donor DUs (by the “inter-donor-DU”). The inter-donor-DU is a form in which routing or rerouting is performed between different DUs of the donor node, for example, as illustrated in FIG. 13. For the inter-donor DU, the Destinations on the upstream side of the BH link (e.g., the BAP address of the donor DU #1 (200D1)) in which the RLF occurs are unroutable. Therefore, all of the routing IDs having the Destinations are unavailable. On the other hand, for the Destinations on the upstream side of another BH link (the BAP address of the donor DU #2 (200D2)), since an RLF is not detected on the path, all of the routing IDs having the Destinations are available.

In step S23, the IAB node 300-T confirms a Destination of the unroutable routing ID.

Specifically, the IAB node 300-T confirms whether the Destination of the unroutable routing ID exists among the Destinations of the routable routing IDs.

When no Destination of the unroutable routing ID exists among the Destinations of the routable routing IDs, the IAB node 300-T includes the Destination of the unroutable routing ID in the additional information of the Type2 Indication.

For example, for the single connectivity described above, since no Destination of the routable routing ID exists, this corresponds to when no Destination of the unroutable routing ID exists among the Destinations of the routable routing IDs. In this case, the additional information includes the Destination of the unroutable routing ID.

In addition, for example, for between the donor DUs described above, the Destination of the unroutable routing ID (the BAP address of the donor DU #1 (200D1)) and the Destination of the routable routing ID (the donor DU #2 (200D2)) are different Destinations. Therefore, this corresponds to when no Destination of the unroutable routing ID (the BAP address of the donor DU #1 (200D1)) exists among the Destinations of the routable routing IDs (the BAP address of the donor DU #2 (200D2)). Therefore, in this case, the additional information includes the Destination of the unroutable routing ID (the BAP address of the donor DU #1 (200D1)).

On the other hand, when the Destination of the unroutable routing ID exists among the Destinations of the routable routing IDs, the IAB node 300-T includes a list of the unroutable routing IDs in the additional information.

For example, as described above, for the intra-donor-DU, even when routing to a certain Destination is unroutable, routing may be routable at the same Destination in some cases because an alternative path exists. Therefore, in this case, the IAB node 300-T includes the list of the unroutable routing IDs in the additional information.

In step S24, the IAB node 300-T transmits the Type2 Indication including the additional information to the child node 300-C.

In step S25, the child node 300-C, in response to receiving the Type2 Indication, determines that all of the routing IDs having the Destination are unavailable. Since the additional information includes the unroutable Destination, the child node 300-T determines that the routing ID including the Destination is an unavailable routing ID.

In step S26, the child node 300-T ends a series of processing operations.

### Third Embodiment

In the first embodiment described above, one type of DC includes EN-DC. In EN-DC, as described above, the MCG performs processing related to control (C-Plane), and the SCG performs processing related to data (U-Plane). Therefore, even when an RLF occurs on the MCG side, at least data transmission can be maintained. Also for the NR-DC, the situation the same as EN-DC may arise when the SCG performs processing related to data and the MCG performs processing related to control, for example.

In such a case, the IAB node 300-T is also capable of not transmitting the Type2 Indication to the child node 300-C even when an RLF occurs on the MCG side. This is because the IAB node 300-T can transfer data to the parent node 300-P2 by using the SCG.

However, when the IAB node 300-T determines the type of DC or determines which of the SCG and the MCG is performing the processing related to the data, the processing may be complicated. If the IAB node 300-T can transmit or not transmit the Type2 Indication without determining the type of DC or the like, the IAB node 300-T can easily perform the processing.

Therefore, the third embodiment describes an example in which the Type2 Indication is not transmitted when a route that is unavailable due an RLF is not present in a routing table and/or a mapping table. The third embodiment also describes an example in which the Type2 Indication is transmitted when the unavailable route is present in the routing table and/or the mapping table.

To be more specific, first, the relay node (e.g., the IAB node 300-T) is configured with dual connectivity in which the first parent node (e.g., the parent node 300-P1) managing the master cell group is the master node and the second parent node (e.g., the parent node 300-P2) managing the secondary cell group is the secondary node. Second, the relay node detects a radio link failure occurring in the first backhaul link between the relay node and the first parent node, and/or the second backhaul link between the relay node and the second parent node. Third, the relay node transmits the first notification (e.g., the Type2 Indication) to the child node (e.g., the child node 300-C), the first notification indicating that recovery from the radio link failure is being attempted, when first route information indicating a route that is unavailable due to the radio link failure is present in the routing table and/or the mapping table, and does not transmit the first notification to the child node when the first route information is not present in the routing table and/or the mapping table.

Accordingly, for example, the IAB node 300-T, even when detecting an RLF on the MCG side, can ignore the RLF and is capable of not transmitting the Type2 Indication when the route information on the MCG side is not present in the routing table and/or the mapping table. Therefore, even when EN-DC is configured for the IAB node 300-T and an RLF occurs on the MCG side, the IAB node 300-T is capable of not transmitting the Type2 Indication. Therefore, the IAB node 300-T can transmit the Type2 Indication with complicated processing being suppressed.

### Operation Example According to Third Embodiment

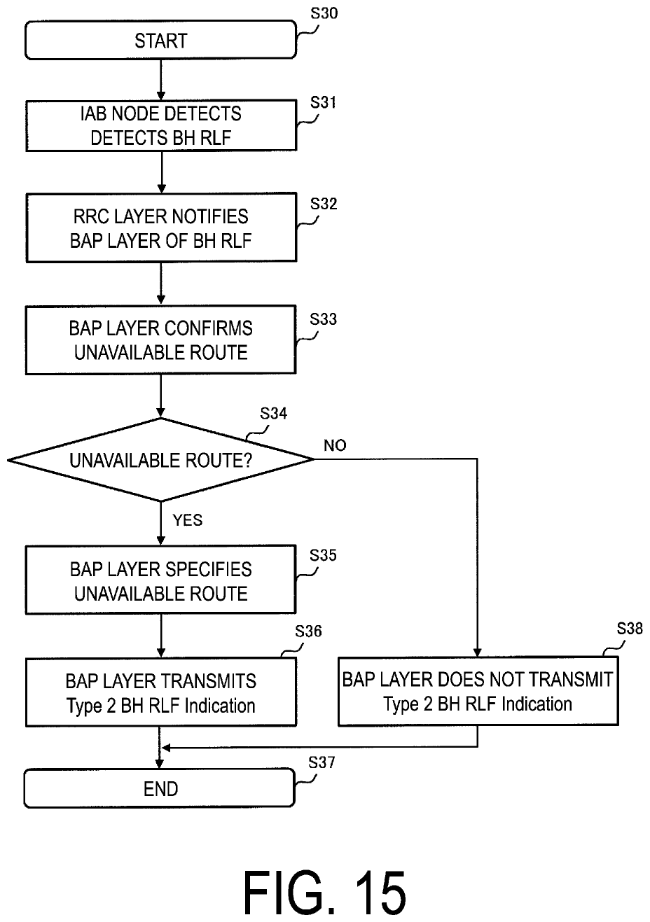

FIG. 15 is a flowchart illustrating an operation example according to the third embodiment.

The IAB node 300-T starts processing in step S30 as illustrated in FIG. 15.

Note that the DC configuration is made for the IAB node 300-T between steps S30 and S31 as in the first embodiment. The IAB node 300-T can wirelessly communicate with the parent nodes 300-P1 and 300-P2 at the same time.

In step S31, the IAB-MT of the IAB node 300-T detects an RLF. The IAB node 300-T may continue to perform an RRC reestablishment procedure, an MCG failure information procedure, and an SCG failure information procedure.

In step S32, the RRC layer of the IAB-MT of the IAB node 300-T outputs first information indicating that the RLF has been detected (or that the BH link is being restored) to the BAP layer of the IAB-DU of the IAB node 300-T.

For example, the RRC layer may output the first information to the BAP layer of the IAB-DU of the IAB node 300-T via the F1AP layer of the IAB-DU of the IAB node 300-T.

The first information may include information indicating in which link the RLF occurs. Specifically, the first information may include information indicating whether the RLF occurs in the MCG or whether the RLF has occurs in the SCG. The first information may include an egress BH link ID identifying a BH link in which the RLF occurs as an egress BH link. Further, the first information may include a next hop BAP address of the IAB node 300-T on the BH link in which the RLF occurs. The first information may include at least one selected from the group consisting of information indicating the MCG or the SCG, the egress BH link ID, and the next hop BAP address.

In step S33, the BAP layer confirms whether an unavailable route is present in response to the input of the first information. Specifically, the BAP layer confirms whether the route information corresponding to (or including) the first information is present in a routing configuration (or the routing table) and/or a mapping configuration (or the mapping table).

First, the confirmation related to the routing table is as follows, for example.

That is, the BAP layer confirms whether the route information (here, the routing ID and/or the egress BH link) corresponding to the first information is present in the routing table.

Second, the confirmation related to the mapping table is as follows, for example.

That is, the BAP layer confirms whether the route information (here, the egress BH RLC channel) corresponding to the first information is present in the mapping table.

In step S34, when an unavailable route is present in the routing table and/or the mapping table (YES in step S34), the BAP layer performs processing of step S35. On the other hand, in step S34, when an available route is not present in the routing table and/or the mapping table (NO in step S34), the BAP layer performs processing of step S38.

When an unavailable route is present (YES in step S34) corresponds to when the route information corresponding to the first information is present in the routing table and/or the mapping table. For example, that is when the route information on the MCG side is present in the routing table and/or the mapping table when an RLF occurs on the MCG side. In such a case, the BAP layer performs steps S35 and S36.

When an unavailable route is not present (NO in step S34) corresponds to when the route information corresponding to the first information is not present in the routing table and/or the mapping table. For example, that is when the route information on the MCG side is not present in the routing table and/or the mapping table even when an RLF occurs on the MCG side. In such a case, the BAP layer does not transmit the Type2 indication even when receiving the first information from the RRC layer. That is, even when an RLF occurs on the MCG side, when there is no corresponding entry (or corresponding route information) in the routing table and/or the mapping table, the BAP layer is capable of not transmitting the Type2 Indication. Therefore, the BAP layer performs processing of step S38.

In step S35, the BAP layer specifies the unavailable route.

Here, the BAP layer specifies the unavailable route for a lower node (e.g., the child node 300-C) to grasp. Specifically, when the BAP layer uses the routing ID as the route information to determine steps S33 and S34 (when the routing ID corresponds to the unavailable route), the BAP layer may use the routing ID as it is to specify as the unavailable route. When the BAP layer uses the egress BH link as the route information to determine steps S33 and S34 (when the egress BH link corresponds to the unavailable route), the BAP layer may specify an ingress BH link corresponding to the egress BH link as the unavailable route. Further, when the BAP layer uses the egress BH RLC channel as the route information to determine steps S33 and S34 (when the egress BH RLC channel corresponds to the unavailable route), the BAP layer may specify an ingress BH RLC channel corresponding to the egress BH RLC channel as the unavailable route.

In step S36, the BAP layer transmits the Type2 Indication. The BAP layer may transmit the Type2 Indication only to the child node 300-C linked to the route specified in step S35. For example, the BAP layer may transmit the Type2 Indication only to the child node 300-C linked to the ingress BH link specified as the unavailable route. In this case, the BAP layer may not transmit the Type2 Indication to the child node that is not linked to the specified ingress BH link.

Note that the Type2 Indication may include an unavailable route as the additional information. The unavailable route may be an unavailable routing ID or the like.

In step S37, the IAB node 300-T ends a series of processing operations.

On the other hand, in step S38, the BAP layer does not transmit the Type2 Indication.

In step S38, the IAB node 300-T ends a series of processing operations.

### Variation of Third Embodiment

In the example described according to the third embodiment, the BAP layer performs the processing from step S33 to step S35. For example, the F1AP layer of the IAB-DU of the IAB node 300-T may perform the processing from step S33 to step S35. The operation in this case is as follows, for example.

Specifically, in step S32, the RRC layer of the IAB-DU of the IAB node 300-T outputs the first information to the F1AP layer.

In steps S33 to S35, the F1AP layer instead of the BAP layer may perform the same and/or similar processing. In this case, the F1AP layer outputs the unavailable route specified in step S35 to the BAP layer of the IAB-DU of the IAB node 300-T. Then, the BAP layer may perform processing of step S36 and subsequent steps.

### Fourth Embodiment

In the example described according to the third embodiment, the Type2 Indication is not transmitted when a route that is unavailable due an RLF is not present in the routing table and/or the mapping table, and the Type2 Indication is transmitted when the unavailable route is present.

The fourth embodiment describes an example in which the Type3 indication is not transmitted when a route in which recovery from the RLF has occurred is not present in the routing table and/or the mapping table, and the Type3 indication is transmitted when the route in which recovery from the RLF has occurred is present in the routing table and/or the mapping table.

Specifically, first, the relay node (e.g., the IAB node 300-T) detects recovery from the radio link failure. Second, the relay node transmits the second notification (e.g., the Type3 Indication) to the child node (e.g., the child node 300-C), the second notification indicating recovery from the radio link failure, when second route information indicating a route that is available due to recovery from the radio link failure having occurred is present in the routing table and/or the mapping table, and does not transmit the second notification to the child node when the second route information is not present in the routing table and/or the mapping table.

Accordingly, for example, the Type3 indication can be transmitted with the complicated processing being suppressed also in the fourth embodiment, as in the third embodiment.

### Operation Example According to Fourth Embodiment

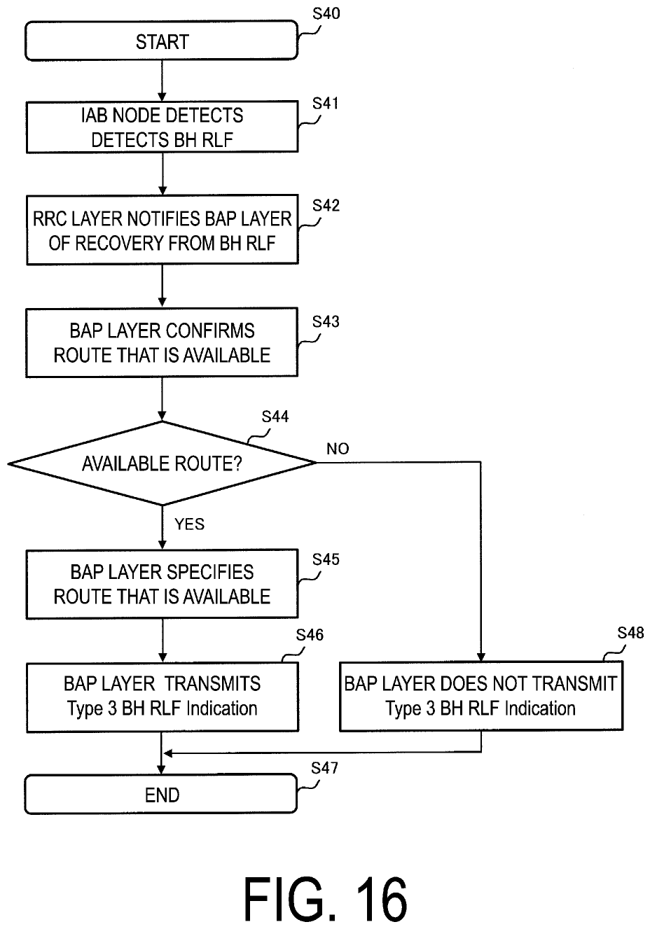

FIG. 16 is a flowchart illustrating an operation example according to the fourth embodiment.

The IAB node 300-T starts processing in step S40 as illustrated in FIG. 16.

Note that the DC configuration is made for the IAB node 300-T between steps S40 and S41 as in the third embodiment. The IAB node 300-T can wirelessly communicate with the parent nodes 300-P1 and 300-P2 at the same time.

In step S41, the IAB-MT of the IAB node 300-T detects an RLF.

In step S42, the RRC layer of the IAB-MT of the IAB node 300-T outputs second information indicating recovery from the RLF to the BAP layer of the IAB-DU of the IAB node 300-T.

The second information may include information indicating in which link recovery from the RLF has occurred. Specifically, the second information may include information indicating whether the recovery is in the MCG or the recovery is in the SCG. The second information may include an egress BH link ID identifying a BH link in which recovery from the RLF has occurred as an egress BH link. Further, the second information may include a next hop BAP address of the IAB node 300-T on the BH link in which recovery from the RLF has occurred. The second information may include at least one selected from the group consisting of information indicating the MCG or the SCG, the egress BH link ID, and the next hop BAP address.

In step S43, the BAP layer confirms whether a route that is available is present in response to the input of the second information. Specifically, the BAP layer confirms whether the route information corresponding to (or including) the second information is present in the routing configuration (or the routing table) and/or the mapping configuration (or the mapping table).

First, the confirmation related to the routing table is as follows, for example.

That is, the BAP layer confirms whether the route information (here, the routing ID and/or the egress BH link) corresponding to (or including) the second information is present in the routing table.

Second, the confirmation related to the mapping table is as follows, for example.

That is, the BAP layer confirms whether the route information (here, the egress BH RLC channel) corresponding to (or including) the second information is present in the mapping table.

In step S44, when a route that is available is present in the routing table and/or the mapping table (YES in step S44), the BAP layer performs processing of step S45. On the other hand, in step S44, when a route that is available is not present in the routing table and/or the mapping table (NO in step S44), the BAP layer performs processing of step S48.

When a route that is available is present (YES in step S44) corresponds to when the route information corresponding to the second information is present in the routing table and/or the mapping table. For example, that is when the route information on the MCG side is present in the routing table and/or the mapping table when recovery from the RLF occurs on the MCG side. In such a case, the BAP layer performs steps S45 and S46.

On the other hand, when a route that is available is not present (NO in step S44) corresponds to when the route information corresponding to the second information is not present in the routing table and/or the mapping table. For example, that is when the route information on the MCG side is not present in the routing table and/or the mapping table even when the recovery from the RLF occurs on the MCG side. In such a case, the BAP layer does not transmit the Type3 indication even when receiving the second information from the RRC layer. Therefore, the BAP layer performs processing of step S48.

In step S45, the BAP layer specifies the unavailable route. The BAP layer specifies a route that is available for a lower node (e.g., the child node 300-C) to grasp. Specifically, the BAP layer may specify the routing ID, the ingress BH link, or the ingress BH RLC channel as the available route, as in the third embodiment.

In step S46, the BAP layer transmits the Type3 Indication. The BAP layer may transmit the Type3 Indication only to the child node 300-C linked to the route specified in step S45. For example, the BAP layer may transmit the Type3 Indication only to the child node 300-C linked to the specified ingress BH link. In this case, the BAP layer may not transmit the Type3 Indication to the child node that is not linked to the specified ingress BH link.

Note that the Type3 Indication may include a route that is available as additional information. The route that is available includes a routing ID that is available.

In step S47, the IAB node 300-T ends a series of processing operations.

On the other hand, in step S48, the BAP layer does not transmit the Type3 Indication when an available route is not present (NO in step S44).

In step S48, the IAB node 300-T ends a series of processing.

### Variation of Fourth Embodiment

The F1AP layer of the IAB-DU of the IAB node 300-T may perform the processing from step S43 to step S45, as in the variation of the third embodiment. That is, in steps S43 to S45, the F1AP layer instead of the BAP layer may perform the same and/or similar processing. In this case, the F1AP layer outputs the route information specified in step S45 to the BAP layer of the IAB-DU of the IAB node 300-T. Then, the BAP layer may perform processing of step S46 and subsequent steps.

### Fifth Embodiment

In the description according to the third embodiment, the IAB node 300-T may transmit the Type2 Indication including the unavailable routing ID to the child node 300-C. In the description according to the fourth embodiment, the IAB node 300-T may transmit the Type3 Indication including the available routing ID to the child node 300-C.

The fifth embodiment describes a specific operation example in the BAP layer when the child node 300-C receives the Type2 Indication including the unavailable routing ID and when the child node 300-C receives the Type3 Indication including the available routing ID.

To be more specific, first, the relay node (e.g., the IAB node 300-T) transmits the first notification (e.g., the Type2 Indication) to the child node (e.g., the child node 300-C), the first notification indicating that recovery from the radio link failure is being attempted. Second, the child node performs first routing processing, in response to receiving the first notification including a first routing ID that is unavailable, on an assumption that the first routing ID is not present in the routing table. Third, the child node performs second routing processing, in response to receiving the second notification (e.g., the Type3 Indication) including the available second routing ID, by using an entry in the routing table including the second routing ID.

This allows the child node 300-C to perform appropriate processing, even when receiving the Type2 Indication including the routing ID that is unavailable due to the RLF and receiving the Type3 Indication including the routing ID that is available due to the recovery from the RLF.

### Operation Example of Fifth Embodiment

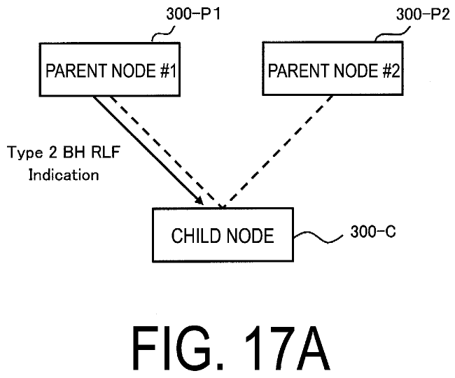

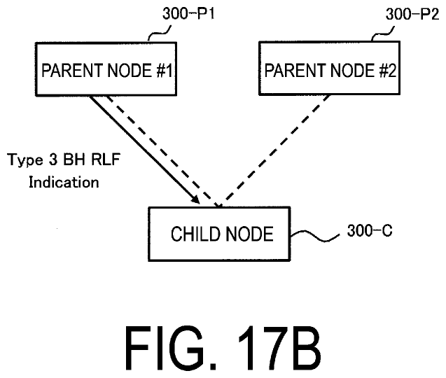

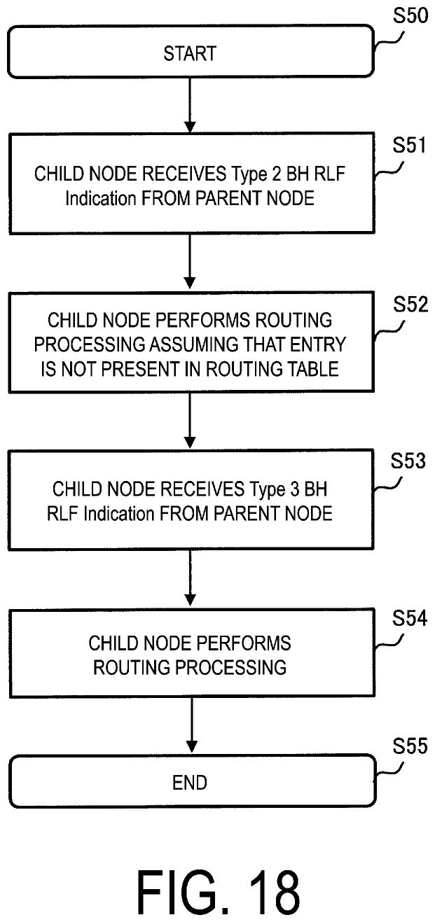

FIGS. 17A and 17B are diagrams illustrating inter-node configuration examples according to the fifth embodiment. FIG. 18 is a flowchart illustrating an operation example according to the fifth embodiment. The operation example illustrated in FIG. 18 is described with reference to the configuration examples illustrated in FIGS. 17A and 17B.

The child node 300-C starts processing in step S50 as illustrated in FIG. 18.

In step S51, the BAP layer of the child node 300-C receives the Type2 Indication from the parent node 300-P1. FIG. 17A illustrates an example in which the child node 300-C receives the Type2 Indication. The Type2 Indication includes the routing ID that is unroutable due to an RLF as the additional information.

Referring back to FIG. 18, in step S52, the BAP layer of the child node 300-C performs the routing processing on an assumption that the entry is not present in the routing table. Specifically, the BAP layer considers that the entry including the routing ID included in the Type2 Indication is not present in the routing table (or is an unavailable entry) to perform the routing processing. In this case, since the entry is present in the routing table, the BAP layer searches the routing table for an entry matching the Destination of the routing ID, and performs the local rerouting to the routing ID of the entry. The first routing processing corresponds to such local rerouting processing, for example. FIG. 17A illustrates an example in which the child node 300-C switches the path to that for the parent node 300-P2 by the local rerouting processing.

Referring back to FIG. 18, in step S53, the child node 300-C receives the Type3 Indication from the parent node 300-P1. FIG. 17B illustrates an example in which the child node 300-C receives the Type3 Indication. The Type3 Indication includes the routing ID that is routable due to the recovery from the RLF as the additional information.

Referring back to FIG. 18, in step S54, the child node 300-C searches the routing table for an entry corresponding to the routing ID, and when the entry is present, resumes the use of the entry and performs normal routing processing. That is, since the entry is present in the routing table, the child node 300-C stops the local rerouting processing and performs the normal routing processing. FIG. 17B illustrates an example in which the child node 300-C switches the path from the parent node 300-P2 to the parent node 300-P1 by the local rerouting processing.

In step S55, the child node 300-C ends a series of processing operations.

### Sixth Embodiment

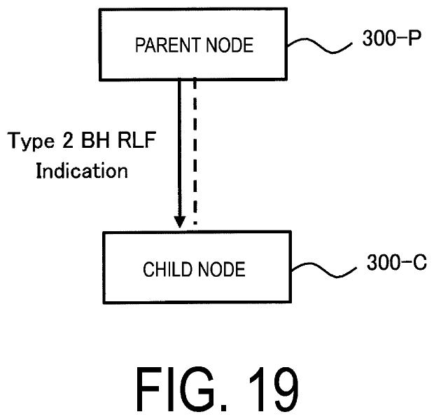

FIG. 19 is a diagram illustrating an inter-node configuration example according to a sixth embodiment.

As illustrated in FIG. 19, the child node 300-C is assumed to receive the Type2 Indication from the parent node 300-P. In this case, when the child node 300-C cannot receive the Type3 Indication or the Type4 Indication from the parent node 300-P thereafter, the child node 300-C may not know what kind of processing should be performed.

This may be because the parent node 300-P cannot transmit the Type3 Indication and the Type4 Indication for some reason. In addition, even if the parent node 300-P transmits the Type3 Indication and the Type4 Indication, the child node 300-C may not be able to receive them for some reason.

Such a case may cause a mismatch between the intention of the parent node 300-P and the operation of the child node 300-C, and thus, the intended operation is not achieved in the entire topology to deteriorate efficiency. In particular, for the single connectivity as illustrated in FIG. 19, the child node 300-C cannot perform transmission to the parent node 300-P in the upstream direction.

Therefore, the sixth embodiment describes an example in which the child node 300-C starts a count by a timer when receiving the Type2 Indication, and starts restoration processing for the BH link when a count value reaches a predetermined value.

Specifically, first, the relay node (e.g., the child node 300-C) receives configuration of the timer value from the donor node (e.g., the donor node 200). Second, the relay node receives the first notification (e.g., the Type2 Indication) from the parent node (e.g., the parent node 300-P), the first notification indicating that recovery from a radio link failure in a backhaul link of the parent node is being attempted. Third, the relay node starts a count by the timer in response to receiving the first notification. Fourth, the relay node performs the restoration processing when the count value of the timer reaches the timer value without receiving any of the second notification (e.g., the Type3 Indication) indicating recovery from the radio link failure and a third notification (e.g., the Type4 Indication) indicating recovery from the radio link failure has failed.

This can suppress the mismatch between the parent node 300-P and the child node 300-C and bring closer to the intended operation in the entire topology.

### Operation Example According to Sixth Embodiment

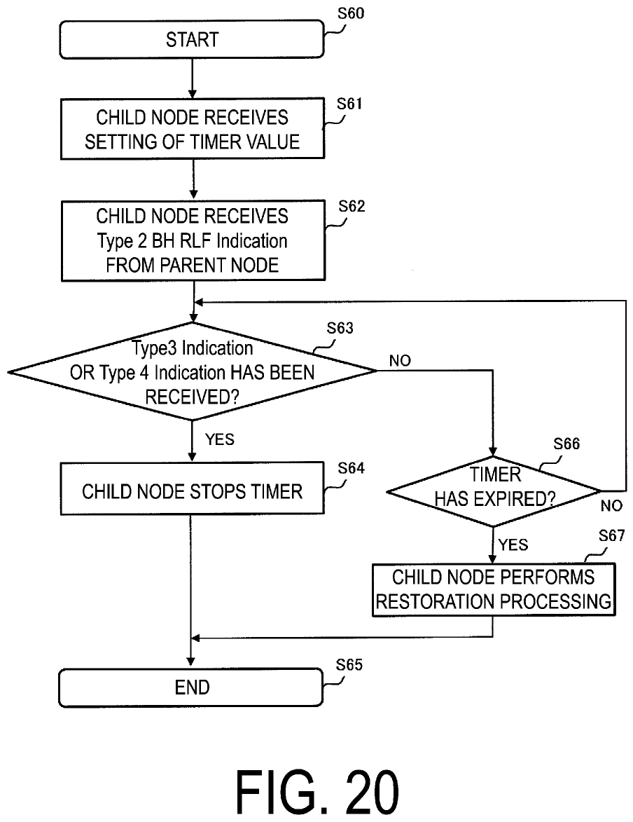

FIG. 20 is a flowchart illustrating an operation example according to the sixth embodiment.

The child node 300-C starts processing in step S60 as illustrated in FIG. 20.

In step S61, the child node 300-C receives configuration of a timer value from the donor node 200 or the parent node 300-P. The child node 300-C may receive the configuration of the timer value from the donor node 200 using an RRC message or a F1AP message. The child node 300-C may receive the configuration of the timer value from the parent node 300-P using a BAP Control PDU.

In step S62, the child node 300-C receives the Type2 Indication from the parent node 300-P. The child node 300-C starts a count by the timer in response to receiving the Type2 Indication.

In step S63, the child node 300-C determines whether the child node 300-C receives the Type3 Indication or the Type4 Indication from the parent node 300-P. The child node 300-C, when receiving the Type3 Indication or the Type4 Indication from the parent node 300-P (YES in step S63), performs processing of step S64. On the other hand, the child node 300-C, when not receiving the Type3 Indication or the Type4 Indication from the parent node 300-P (NO in step S63), performs processing of step S66.

In step S64, the child node 300-C stops the count by the timer.

In step S65, the child node 300-C ends a series of processing operations.

On the other hand, in step S66, the child node 300-C determines whether the count value of the timer reaches the timer value (whether the timer expires). When the count value of the timer reaches the timer value (YES in step S66), the child node 300-C performs processing of step S67. On the other hand, when the count value of the timer does not reach the timer value (NO in step S66), the child node 300-C proceeds the processing to step S63 and the above-described processing is repeated.

In step S67, the child node 300-C performs restoration processing.

The restoration processing may be a declaration of RLF. For example, the child node 300-C may declare an RLF that occurs in the BH link of the parent node 300-P.

The restoration processing may be performing the RRC reestablishment procedure. For example, the child node 300-C may initiate the RRC re-establishment procedure with respect to the parent node 300-P.

Furthermore, the restoration processing may be performing the MCG failure information procedure or the SCG failure information procedure according to the additional information included in the Type2 indication. For example, the child node 300-C may perform the MCG failure information procedure when information indicating an RLF on the MCG side is included as the additional information, and may perform the SCG failure information procedure when information indicating an RLF on the SCG side is included as the additional information.

In step S65, the child node 300-C ends a series of processing operations.

### Seventh Embodiment

The 3GPP has studied how to perform rerouting in a network (or a topology) formed by a plurality of IAB nodes 300.

Currently, for routing and rerouting, there are the following scenarios.
(S1) Intra-CU/Intra-donor-DU
(S1-1) Routing
(S1-2) Rerouting
(S2) Intra-CU/Inter-donor-DU
(S2-1) Routing
(S2-2) Rerouting
(S3) Inter-CU
(S3-1) Routing
(S3-2) Rerouting

In consideration of such scenarios, it is expected to improve the reliability, flexibility, and low latency of packet transfer in the topology by studying a procedure or processing common to the scenarios or studying a procedure or processing of each individual scenario.

Note that the routing is, for example, to control which IAB node 300 the received packet is transferred to.

Here, each scenario is described with a focus on the rerouting.

### (S1) “Intra-CU/Intra-Donor-DU” Scenario

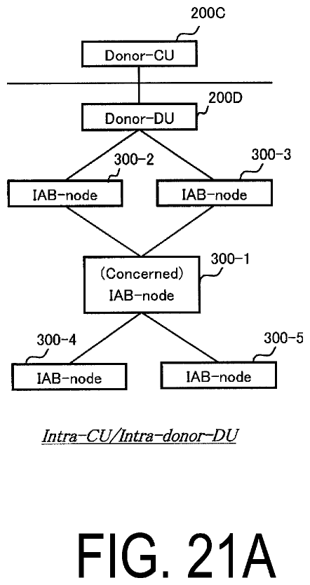

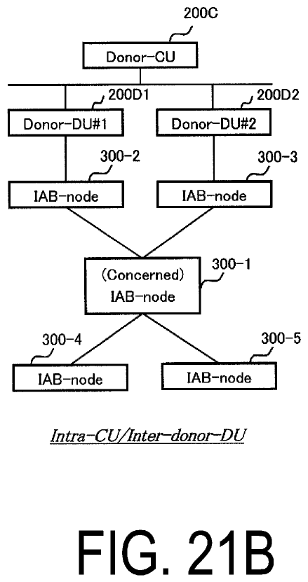

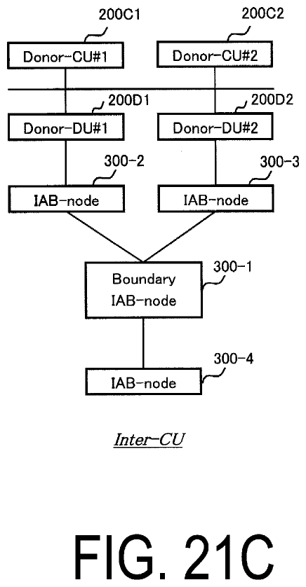

FIG. 21A illustrates a configuration example of a topology in the “intra-CU/intra-donor-DU” scenario.

The rerouting (S1-2) in this scenario is so-called local rerouting. For example, the IAB node 300-1, when detecting the BH RLF for the IAB node 300-2, switches the route of the packet in the uplink direction to the route via an IAB node 300-3 which is the alternative path to perform the rerouting.

### (S2) “Intra-CU/Inter-Donor-DU” Scenario

FIG. 21B is a diagram illustrating a configuration example of a topology in the “intra-CU/inter-donor-DU” scenario.

Regarding the rerouting in the IAB node 300-1, for example, assume that the path via the IAB node 300-2 is switched to the path (alternate path) via the IAB node 300-3. In this case, the donor DU that is the destination of the packet is changed from the donor DU #1 (200D1) to the donor DU #2 (200D2). Specifically, the destination BAP address of the packet is changed. Therefore, the 3GPP agreed on rewriting a BAP header in this scenario. The rewriting of the BAP header is to rewrite the BAP header from a previous routing ID to a new routing ID.

(S3) “Inter-CU” Scenario FIG. 21C is a diagram illustrating a configuration example of a topology in the “inter-CU” scenario.

As illustrated in FIG. 21C, in this scenario, two different CUs of a donor CU #1 (200C1) and a donor CU #2 (200C2) are provided. The donor CU #1 (200C1) is connected to the donor DU #1 (200D1), and the donor CU #2 (200C2) is connected to the donor DU #2 (200D2).

In general, different donor CUs form different topologies. That is, a topology (first topology) formed in a path from the donor CU #1 (200C1) to the IAB node 300-1 may be different from a topology (second topology) formed in a path from the donor CU #2 (200C2) to the IAB node 300-1. The IAB node 300-1 is located at a boundary of two different topologies. The IAB node 300-1 like this may be referred to as a boundary IAB node.

Regarding the rerouting in this scenario, for example, the boundary IAB node 300-1 may transfer packets destined to the donor DU #1 (200D1) via the alternate path on the topology in the donor CU #2 (200C2).

However, the 3GPP agreed that the rerouting in this scenario may be applied to the donor CU #2 (200C2) which is the target donor node in the RRC reestablishment state while leaving the F1 connection with the donor CU #1 (200C1) which is the source donor node in the boundary IAB node 300-1.

### Communication Control Method According to Seventh Embodiment

The operation examples, the processing, and the like described in the first embodiment can be applied to the scenarios (S1-2), (S2-2), and (S3-2).

When the first embodiment is applied to the scenario (S2-2), for example, the following is performed. Specifically, as illustrated in FIG. 21B, an IAB node 300-4 and an IAB node 300-5 receive the Type2 Indication from the IAB node 300-1. The Type2 Indication includes the additional information described in the first embodiment. The IAB node 300-4 and the IAB node 300-5 receive also the Type3 Indication from the IAB node 300-1. The Type3 Indication includes the additional information described in the first embodiment.

When the first embodiment is applied to the scenario (S2-3), for example, the following is performed. Specifically, as illustrated in FIG. 21C, the IAB node 300-4 receives the Type2 Indication from the IAB node 300-1. The Type2 Indication includes the additional information described in the first embodiment. The IAB node 300-4 receives also the Type3 Indication from the IAB node 300-1. The Type3 Indication includes the additional information described in the first embodiment.

The operation examples, the processing, and the like described in the second embodiment can be also applied to the scenario (S3-2). Note that since the scenario (S2-2) is described in the second embodiment, a description thereof is omitted.

When the second embodiment is applied to the scenario (S3-2), for example, the following is performed. Specifically, as illustrated in FIG. 21C, the IAB node 300-1 detects an RLF in the BH link with the IAB node 300-2. The IAB node 300-1 confirms the BAP address of the donor DU #1 (200D1) as a Destination of an unroutable routing ID. The IAB node 300-1 transmits the Type3 Indication including the BAP address to the IAB node 300-4.

The operation examples, the processing, and the like described in the third embodiment can be applied to the scenarios (S1-2), (S2-2), and (S3-2). Specifically, for example, the IAB node 300-1, when detecting an RLF in the BH link between the IAB node 300-1 and the IAB node 300-2, does not transmit the Type2 Indication to the lower node when the route information unavailable due to the RLF is not present in the routing table and/or the mapping table. The IAB node 300-1 transmits the Type2 Indication to the lower node when the route information unavailable due to the RLF is present in the routing table and/or the mapping table.

The operation examples, the processing, and the like described in the fourth embodiment can be applied to the scenarios (S1-2), (S2-2), and (S3-2). Specifically, for example, the IAB node 300-1, when detecting recovery from the RLF in the BH link between the IAB node 300-1 and the IAB node 300-2, does not transmit the Type3 Indication to the lower node when the route information available due to the recovery is not present in the routing table and/or the mapping table. The IAB node 300-1 transmits the Type3 Indication to the lower node when the route information available due to the recovery is present in the routing table and/or the mapping table.

The operation examples, the processing, and the like described in the fifth embodiment can be applied to the scenarios (S1-2), (S2-2), and (S3-2). Specifically, the IAB node 300-4 receives the Type2 Indication from the IAB node 300-1. When the routing ID that is unavailable due to the RLF is included as the additional information, the IAB node 300-4 performs the first routing processing on an assumption that the entry including the routing ID is not present in the routing table. The IAB node 300-4 receives also the Type3 Indication from the IAB node 300-1. When the routing ID that is available due to the recovery from the RLF is included as the additional information, the IAB node 300-4 performs the first routing processing on an assumption that the entry including the routing ID is not present in the routing table.

The operation examples, the processing, and the like described in the sixth embodiment can be applied to the scenarios (S1-2), (S2-2), and (S3-2). Specifically, the IAB node 300-4 starts a count by the timer when receiving the Type2 Indication from the IAB node 300-1, and performs the restoration processing when the count value reaches the timer value.

### Eighth Embodiment

In the examples described in the above embodiments, the local rerouting is started (or triggered) in response to receiving the Type2 Indication, or the operation of the local rerouting is stopped in response to receiving the Type3 Indication.

The IAB node 300 may report the triggering and stopping of the local rerouting to the donor node 200.

The report may include cause information indicating a cause of the triggering or stopping. The cause information may be the additional information included in the Type2 Indication (the first embodiment, the second embodiment, and the fifth embodiment) or may be the additional information included in the Type3 Indication (the first embodiment).

The report may include information of a route on which the local rerouting is triggered or stopped. The route information may be the routing ID or the BH RLC channel ID.

The IAB node 300 may transmit the report to the donor node 200 immediately upon triggering or stopping the local rerouting. Alternatively, the IAB node 300 may transmit the report at a later time. When transmitting the report at a later time, the IAB node 300 may record (log) the triggering or stopping, the cause information, and the route information upon triggering or stopping the local rerouting. The IAB node 300 may transmit the record (log) to the donor node 200 as the report in response to a request from the donor node 200.

### OTHER EMBODIMENTS

The embodiments, operation examples, processing, or steps described in the first to eighth embodiments can be combined with each other. All or some of the first to eight embodiments can be appropriately combined as long as no inconsistencies are introduced. By such a combination, the procedure or the processing may be made common to all scenarios.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing the processes to be performed by the UE 100 or the gNB 200 may be integrated, and at least part of the UE 100 or the gNB 200 may be configured as a semiconductor integrated circuit (a chipset or an SoC).

Although embodiments have been described in detail with reference to the drawings, a specific configuration is not limited to those described above, and various design modifications and the like can be made without departing from the scope of the present disclosure.

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

### Supplementary Note

### Introduction

eIaB (Enhancements to Integrated Access and Backhaul for NR) aims at enhancing topology adaptation including support for BH RLF Indication and local rerouting.

In this supplementary note, details of Type2/3 BH RLF are described.

### DISCUSSION

### Transmission of Type2 Indication for Dual Connectivity

In RAN2 #114-e, RAN2 agreed on the trigger conditions for the Type2 Indication as follows.

A trigger for generating the Type2 Indication is when an RLF is detected. Further study is needed for both the single and dual connectivity cases.

For the single connectivity with a parent node, the agreement is very easy. On the other hand, for the dual connectivity with two parent nodes, how the Type2 Indication is transmitted should be further discussed.

RAN2 #113-e agreed on the use case of the Type2 Indication from the viewpoint of a child node as follows.

RAN2 supports the Type2/3 RLF Indication (further study is required for defined operation, effects of TS, and details).

The Type2 RLF Indication can trigger local rerouting.

The Type2 RLF Indication can trigger deactivation of IAB supported by SIBs.

The Type2 RLF Indication can be used as a trigger for stopping or reducing transmission of SRs or BSRs.

In the above context of the agreed items, the expected operation can be considered to be that the child node receiving the Type2 Indication is expected to not transfer the upstream packet to the IAB node transmitting the Type2 Indication due to the BH RLF in the IAB node. This is also consistent with the agreement that “when the IAB node with two parent nodes (via DC) receives a Type2 BH RLF indication from one parent node, the IAB node may trigger local rerouting to the other parent node”.

Observation 1: When the parent node is in the single BH connection, the child node may sometimes not be expected to transfer upstream packets to the IAB node transmitting the Type2 BH RLF Indication.

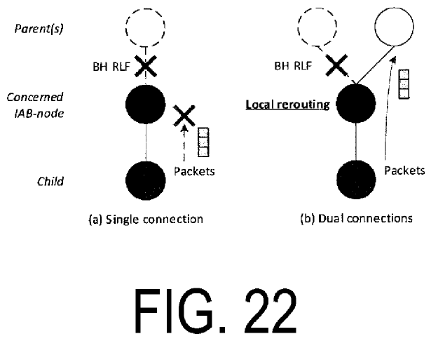

As illustrated in FIG. 22B, when the IAB node has dual connectivity, Observation 1 is not always correct because local rerouting may be performed as a Rel-16 operation.

NOTE: data buffering in a transmitter of a BAP entity is up to the implementation until an RLC-AM entity receives an acknowledgment response. For a BH RLF, the transmitter of the BAP entity may reroute, to the alternative path, the BAP data PDU unacknowledged by the lower layers before the BH RLF.

Therefore, when an alternative path exists even after the BH RLF of the MCG, it remains questionable whether the IAB node should transmit the Type2 Indication. It should be noted that, during the MCG failure information procedure, the IAB node may continue local rerouting.

Observation 2: The child node may transfer upstream packets when the parent node (the IAB node) can perform local rerouting, i.e., due to dual connectivity.

Another scenario of EN-DC is also worth studying. In EN-DC, the MCG link (i.e., MeNB) is only used for control plane signaling, and data is always transferred via the SCG link (i.e., SgNB). In this case, since the SCG RLF directly affects packet transferring of a child node, the IAB node needs to transmit the Type2 indication to the child node. On the other hand, for an MCG RLF (LTE link), the SCG link is still available during the subsequent RRC connection re-establishment procedure, and when the re-establishment fails, the Type4 Indication is transmitted as in Rel-16, so that the Type2 Indication may not be necessary.

Observation 3: In EN-DC, since local rerouting cannot be performed via the MCG (i.e., LTE link), the Type2 BH RLF Indication needs to be transmitted during the SCG RLF (i.e., NR link).

Observation 4: In EN-DC, the Type2 BH RLF Indication does not need to be transmitted during the MCG RLF (i.e., LTE link) since packet transfer is performed always via the SCG (i.e., NR link).

In consideration of the above observations, a simple solution may be to transmit the Type2 Indication when at least one route is unavailable due to a BH RLF. This solution can cover both the single and dual connectivity and also both the NR-DC and EN-DC. For example, during a BH RLF in the single connectivity, all routes are unavailable. In EN-DC, an MCG RLF does not affect any route and an SCG RLF brings all routes to be unavailable. In the NR-DC, a BH RLF may or may not affect some routes depending on the mapping of BH links and routes. Therefore, RAN2 should agree on this unified operation for the trigger condition of the Type2 Indication.

Proposal 1: RAN2 should agree that the Type2 BH RLF Indication is transmitted when at least one route is unavailable during a BH RLF regardless of whether the IAB node is single-connected or dual-connected (including EN-DC).

### Partial Local Rerouting Upon Receiving Type2 Indication

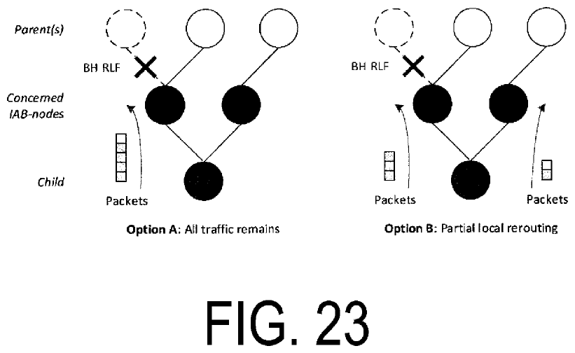

How the child node having dual connectivity operates when receiving the Type2 Indication needs to be studied. When the parent node (the IAB node) detects a BH RLF but can still perform local rerouting, the child node having dual connectivity has the following some operation options (see FIG. 23).

Option A: All upstream traffics remain at this parent node and no local rerouting is performed in the child node.

Option B: Some of the upstream traffics are rerouted to another parent node, that is “partial” local rerouting.

Option A is a simple operation, but the BH RLF causes the parent node to lose either the MCG or the SCG link, which may lead to overload of the parent node. On the other hand, Option B can distribute the load to two parent nodes of the child node, although the Type2 Indication needs to carry the additional information. Therefore, Option B is expected to be effective to improve the performance of the entire topology.

Observation 5: When receiving the Type2 BH RLF Indication, the child node can have an option whether to perform the “partial” local rerouting for better load distribution (i.e., Option B).

Proposal 2: RAN2 needs to discuss whether to perform the “partial” local rerouting in the child node (i.e., Option B) when the parent node in the dual connectivity experiences a BH RLF.

When the partial rerouting (i.e., Option B) is the preferred operation, as in Proposal 2, the child node needs to know which route is unavailable because the child must determine which traffic is left on the original route and which traffic should be subject to local rerouting. This can be easily known when the Type2 Indication includes a routing ID that is unavailable due to a BH RLF. The child node receiving the Type2 Indication considers the routing ID notified by the Type2 Indication to be unavailable, and the BAP layer of the child node performs local rerouting. Therefore, RAN2 should agree on these operations in the concerned node and the child nodes.

Proposal 3: RAN2 should agree that the Type2 BH RLF Indication indicates a routing ID that is unavailable due to a BH RLF.

Proposal 4: RAN2 should agree that when the routing ID is indicated in the received Type2 BH RLF Indication, the child node considers the routing ID to be unavailable.

### Donor Controllability for Type2 Indication

The most promising use case in the Type2 Indication is that the child node performs local rerouting, as agreed by RAN2. In RAN2 #114-e, as in Rel-16, how the Type2 and the Type4 are coordinated was discussed, because a child node declares a BH RLF by the Type4 Indication to finally perform local rerouting. It has been pointed out that local rerouting upon receiving the Type2 is configurable by the providing side. This makes sense because the providing side manages the objects of the entire topology, and knows the recent performance of the entire topology.

Proposal 5: RAN2 should agree that the donor configures the IAB node regarding whether to perform local rerouting upon receiving the Type2 BH RLF Indication.

Further, the providing side needs to be allowed to configure the IAB node regarding whether to transmit the Type2 Indication when a BH RLF is detected. For example, when the IAB node implements the functions of Rel-17 and its child nodes support only Rel-16 (“mixed” arrangement), the providing side can turn it off.

Proposal 6: RAN2 should agree that the donor side configures the IAB node regarding whether to transmit the Type2 BH RLF Indication when the BH RLF is detected.

### Type3 Indication for Single Connectivity and Dual Connectivity

In RAN2 #114-e, RAN2 agreed on the trigger conditions for the Type3 Indication as follows.

A trigger for transmitting the Type3 RLF Indication is a normal recovery after a BH RLF. Further study is required for both the single connectivity and the dual connection.

A common understanding for the Type3 is considered to restore the operation of the child node initiated in response to receiving the Type2. Therefore, the Type3 Indication is effective only when the child node receives the Type2 Indication. Since only the Type2 Indication depends on these cases, such a condition for the Type3 Indication is commonly applicable to both the single and dual connectivity, as in Proposal 1 above, for example.

Proposal 7: RAN2 should agree that a Type3 BH RLF Indication is transmitted only when the Type2 BH RLF Indication is transmitted, in addition to the agreed operation, that is, when recovery from the BH RLF is successful, as common to the single connectivity and dual connectivity cases.

If Proposal 1 can be agreed, it would be reasonable to transmit the Type3 Indication only when at least one route is reavailable due to successful BH RLF recovery, i.e., when the state changes from “unavailable” to “available”. This operation can be applied to the single connectivity and dual connectivity cases including the NR-DC and EN-DC as proposed.

Proposal 8: RAN2 should agree that the Type3 BH RLF Indication is transmitted when recovery from the BH RLF is successful and at least one route is reavailable.

If Proposal 3 can be agreed, the routing ID that is reavailable needs to be notified also to the child node. The child node considers these routing IDs to be routable and stops the local rerouting of the relevant traffic.

Proposal 9: RAN2 should agree that the Type3 BH RLF Indication indicates the routing ID that is reavailable due to successful BH RLF recovery.

Proposal 10: RAN2 should agree that when the routing ID is indicated in the received Type3 BH RLF Indication, the child node considers the routing ID to be available.

### Propagation of Type2 Indication

The propagation of the Type2 Indication aims to provide better topology management, such as load distribution and reduced service interruption.

Specifically, various proposals have been made. One of the proposals is that the IAB node receives the Type2 Indication and transfer the Type2 Indication when no alternate path exists. This is consistent with the operation of the IAB node based on Option 1 of Proposal 1. In other words, this condition can be interpreted as a condition that the IAB node does not perform local rerouting, including the partial local rerouting of Proposal 2. Another option is to limit the propagation of the Type2 Indication to one hop, which is expected for stable topology management. The dual connectivity, i.e., Proposal 1 remains dependent on Proposal 2, specifically regarding how the Type2 Indication is transmitted and whether to consider the “partial” local rerouting in the child node. Therefore, details thereof should need to be further studied.

Proposal 11: RAN2 should agree that the propagation of the Type2 Indications to descendant nodes is supported. Detailed conditions, such as transferring only when the IAB node does not perform local rerouting, are further studied.

### Disabling or Reducing SR or BSR by Type2 Indication

RAN2 agreed that “the Type2 Indication can be used to stop or reduce SR or BSR transmission”, but how to handle this agreement is not discussed. Since this is considered to be the operation of the IAB-MT, clear definition should be made. For deactivation and reduction, the “deactivation” may be simpler in terms of specifications. However, this means that SR or BSR can be transmitted only after receiving the Type3 Indication, which may cause scheduling delay. On the other hand, the “reduction” may cause unnecessary interference but may allow scheduling to be resumed immediately after recovery from the BH link. Therefore, RAN2 should discuss whether to support one or both of “deactivation” and “reduction” of SR and/or BSR. When both are supported, this should be configurable by the IAB donor. Further, when “scale-down” is supported, it is unclear how the scale-down of SR and/or BSR should be processed. The concept of the prohibit timer may be reused, but this should be left because further studies are needed at this time.

Proposal 12: RAN2 should agree to define that the IAB-MT stops or reduces SR and/or BSR transmission when receiving the Type2 BH RLF Indication.

Proposal 13: RAN2 should discuss whether one or both of “deactivation” and “reduction” of SR and BSR is supported (i.e., configurable) when receiving the Type2 BH RLF Indication.

1. A communication control method used in a cellular communication system, the communication control method comprising the steps of:
configuring, for a relay node, EN-DC (Evolved universal terrestrial radio access-New radio) dual connectivity in which a first parent node of LTE (Long Term Evolution) is a master node and a second parent of NR is a secondary node;
transmitting, by the relay node, a first notification to a child node in response to a radio link failure being detected in a second backhaul link among first and second backhaul links, the first backhaul link being between the relay node and the first parent node and the second backhaul link being between the relay node and the second parent node, the first notification indicating detection of the radio link failure; and
transmitting, by the relay node, a second notification to the child node in response to recovery from the radio link failure occurs, the second notification being transmitted after transmitting the first notification and indicating recovery from the radio link failure.

2. The communication control method according to claim 1, further comprising
refraining from transmitting, by the relay node, the first notification to the child node in response to a radio link failure being detected in the first backhaul link among the first and second backhaul links.

3. A relay node used in a cellular communication system, the relay node comprising:
a processor circuitry configured to execute:
processing of configuring EN-DC (Evolved universal terrestrial radio access-New radio) dual connectivity in which a first parent node of LTE (Long Term Evolution) is a master node and a second parent node of NR is a secondary node;
processing of transmitting a first notification to a child node in response to a radio link failure being detected in a second backhaul link among first and second backhaul links, the first backhaul link being between the relay node and the first parent node and the second backhaul link being between the relay node and the second parent node, the first notification indicating detection of the radio link failure; and
processing of transmitting a second notification to the child node, the second notification indicating recovery from the radio link failure, in response to recovery from the radio link failure occurs after transmitting the first notification.

4. A mobile communication system comprising the relay node according to claim 3.

5. A chipset for a relay node used in a cellular communication system, the chipset comprising:
a processor circuitry configured to execute:
processing of configuring EN-DC (Evolved universal terrestrial radio access-New radio) dual connectivity in which a first parent node of LTE (Long Term Evolution) is a master node and a second parent node of NR is a secondary node;
processing of transmitting a first notification to a child node in response to a radio link failure being detected in a second backhaul link among first and second backhaul links, the first backhaul link being between the relay node and the first parent node and the second backhaul link being between the relay node and the second parent node, the first notification indicating detection of the radio link failure; and
processing of transmitting a second notification to the child node, the second notification indicating recovery from the radio link failure, in response to recovery from the radio link failure occurs after transmitting the first notification.

6. A non-transitory computer readable medium that stores computer program comprising instructions that, when the computer program is executed by the relay node, cause the relay node to carry out the communication control method according to claim 1.
